(19) United States
(12) Patent Application Publication
(10) Pub. No.: US 2026/0193445 A1
(43) Pub. Date: Jul. 9, 2026

(54) MULTIMATERIAL THIXOTROPIC CONDUCTIVE ELASTOMERS

(71) Applicants: Lawrence Livermore National Security, LLC, Livermore, CA (US); National Technology & Engineering Solutions of Sandia, LLC, Albuquerque, NM (US)

(72) Inventors: Jeremy Aaron Armas, Livermore, CA (US); Michael Ford, Livermore, CA (US); Adam Wade Cook, Albuquerque, NM (US)

(21) Appl. No.: 19/012,689

(22) Filed: Jan. 7, 2025

(51) Int. Cl. C08K 3/04; B82Y 30/00; C08G 77/04; C08K 7/18

(52) U.S. Cl. CPC C08K 3/046; B82Y 30/00; C08G 77/04; C08K 3/041; C08K 7/18

(57) ABSTRACT

A product of additive manufacturing with a multimaterial silicone-based ink includes a printed three-dimensional (3D) structure including filaments in a predefined geometric arrangement. The filaments include a silicone-based matrix and a multimaterial filler. The printed 3D structure is configured to have a predefined electrical resistance characteristic, and the predefined electrical resistance characteristic is a function of the predefined geometric arrangement of the filaments.

This invention was made with Government support under Contract No. DE-AC52-07NA27344 awarded by the United States Department of Energy and Contract No. DE-NA0003525 awarded by the United States Department of Energy/National Nuclear Security Administration. The Government has certain rights in the invention.

### FIELD OF THE INVENTION

The present invention relates to additive manufacturing of silicone materials, and more particularly, this invention relates to multimaterial thixotropic conductive elastomeric material.

### BACKGROUND

Conventional foam elastomers formed with stochastic pore structure suffer from a lack of control from a design, performance, and aging perspective. As a result, there is motivation in elastomer science to develop direct ink write (DIW) three-dimensional (3D) printed compliant foams that have a controlled pore architecture, highly controlled mechanical response, and low compression set. In addition to control of ink architecture, DIW 3D printing allows for the facile production of inks with a variety of special additives that can be used to make functional inks. For example, the addition of conductive fillers into a DIW silicone matrix facilitates the transport of electrical charges throughout the composite, resulting in an overall decrease in material resistance. Such conductive elastomer composites is an expanding area of research to replace conventional metallic electronics that require complex processing and rigid metals that could damage sensitive structures.

Materials for soft electronics, on the other hand, are produced using a facile mixing process that is devoid of any hazardous chemicals (in sharp contrast to metal processing methods). Also, the compliant nature of silicones means that flexible, soft electronics can be safely used in touch-sensitive applications such as robotics, healthcare, structural component monitoring, etc. One drawback to these composites is the relatively large amounts of conductive filler that is needed to reduce the resistance of the composite, typically on the order of >70 wt. %, which results in the loss of rheological thixotropy for applications such as 3D printing, as well as a deterioration in mechanical properties. It is difficult to formulate a printable ink that has high conductivity.

Thus, there is a need for higher conductivity inks for three-dimensional (3D) printing where the ink has electrical conductivity, minimal resistivity, and a thixotropic characteristic for extrusion and formation of self-supporting 3D structures.

### SUMMARY

According to one embodiment, a product of additive manufacturing with a multimaterial silicone-based ink includes a printed three-dimensional (3D) structure including filaments in a predefined geometric arrangement. The filaments include a silicone-based matrix and a multimaterial filler. The printed 3D structure is configured to have a predefined electrical resistance characteristic, and the predefined electrical resistance characteristic is a function of the predefined geometric arrangement of the filaments.

According to another embodiment, a method of forming an electrically conductive three-dimensional structure using a multimaterial silicone-based ink includes determining desired resistance characteristics of a desired structure, and selecting a geometric arrangement of filaments that will provide the resulting desired resistance characteristics of the desired structure. The method further includes printing the desired structure based on the selected geometric arrangement of filaments to impart the desired resistance characteristics on the printed structure, and curing the desired structure to at least a predefined extent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 depicts schematic drawings of electrically conductive three-dimensional structures having controlled porosity, according to one embodiment. Parts (a) and (b) depict top down view of two-dimensional gradients of porosity, and part (c) depicts a three-dimensional cube-like structure having three-dimensional gradients of porosity.

FIG. 2 is a flow chart of a method of forming an electrically conductive three-dimensional structure using a multimaterial silicone-based ink, according to one embodiment.

FIG. 3 is an image of multimaterial-silicone-based samples having low measured resistance, according to one embodiment.

FIG. 4 depicts an image of a three-dimensional printed structure having 50% porosity and images of the multimaterial-silicone-based material, according to one embodiment. Part (a) is an image of a lattice-like structure, part (b) and (c) are images of a magnified view of the material of the structure, part (d) and (e) are images of a larger field of material.

FIG. 5 depicts physical characteristics of multimaterial-silicone-based material having different amounts of electrically conductive filler, according to various embodiments. Part (a) measurement of tensile strength, part (b) measurement of % elongation, part (c) measurement of 25% secant modulus, part (d) measurement of durometer, part (e) measurement of compression set.

FIG. 6 depicts the rheological properties of multimaterial silicone-based inks, according to one embodiment. Part (a) is a plot of storage modulus, and part (b) is a plot of yield stress.

FIG. 7 depicts the storage modulus of multimaterial silicone-based inks during curing with increasing temperature, according to one embodiment.

FIG. 8 depicts an electrically conductive three-dimensional structure having gradient porosity and different measured resistance between reference points of the structure, according to one embodiment. Part (a) is an image of a top down view of the structure including probes positioned at reference point 1 and reference point 2, part (b) is an image of the resistance measurements with the probes positioned at different reference points on the structure.

FIG. 9 illustrates electrical resistance variation according to applied strain of multimaterial silicone-based material, according to one embodiment. Part (a) is a silicone based ink having 0.5 wt. % CNTs, and part (b) is a silicone based ink having 0.8 wt. % CNTs and 20 wt. % Ag/Al particles.

FIG. 10 is a plot of measured resistance of a sample having 1 wt. % CNT during multiple cycles of strain, according to one embodiment.

FIG. 11 is a plot of directionally-dependent electrical resistance variation in response to strain, according to one embodiment.

FIG. 12 is a plot of compression testing of multimaterial silicone-based material, according to one embodiment. Part (a) a lattice-like three-dimensional structure, and part (b) a bulk sample.

FIG. 13A depicts laser etched regions on a surface of an electrically conductive multimaterial-silicone-based three dimensional structure, according to one embodiment. Part (a) is an image of the engraved portion by laser etching, part (b) is a magnified view of the engraved region, and part (c) is a magnified view of an as cured region that has not been etched.

FIG. 13B is an image of the three dimensions of the laser etched structure, according to one embodiment.

FIG. 13C is an image that illustrates the depth of etching on the surface of the three-dimensional structure.

FIG. 14 is a plot of measured resistance of multimaterial silicone-based formulations, according to one embodiment. Part (a) bulk samples formed form cured and uncured resin, and part (b) a cured lattice-like three-dimensional structure.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm #1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive optics described herein. It should be understood that “inks” (and singular forms thereof) may be used interchangeably and refer to a composition of matter comprising a plurality of particles coated with/dispersed throughout a liquid phase such that the composition of matter may be “written,” extruded, printed, or otherwise deposited to form a layer that substantially retains its as-deposited geometry and shape without excessive sagging, slumping, or other deformation, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of the ink (or in some cases multiple inks with different compositions) in sequence.

The following description discloses several preferred structures formed via direct ink writing (DIW), extrusion freeform fabrication, or other equivalent techniques and therefore exhibit unique structural and compositional characteristics conveyed via the precise control allowed by such techniques.

The following description discloses several preferred embodiments of multimaterial thixotropic conductive elastomers and/or related systems and methods.

In one general embodiment, a product of additive manufacturing with a multimaterial silicone-based ink includes a printed three-dimensional (3D) structure including filaments in a predefined geometric arrangement. The filaments include a silicone-based matrix and a multimaterial filler. The printed 3D structure is configured to have a predefined electrical resistance characteristic, and the predefined electrical resistance characteristic is a function of the predefined geometric arrangement of the filaments.

In another general embodiment, a method of forming an electrically conductive three-dimensional structure using a multimaterial silicone-based ink includes determining desired resistance characteristics of a desired structure, and selecting a geometric arrangement of filaments that will provide the resulting desired resistance characteristics of the desired structure. The method further includes printing the desired structure based on the selected geometric arrangement of filaments to impart the desired resistance characteristics on the printed structure, and curing the desired structure to at least a predefined extent.

A list of acronyms used in the description is provided below.
3D Three dimensional
Al/Ag Silver-coated aluminum
AM Additive manufacturing
C Celsius
CNT carbon nanotubes
cSt centiStokes
DIW Direct Ink Write
DPS diphenylsiloxane
ETCH 1-ethynyl-1-cyclohexanol
FCT face centered tetragonal
g gram
HMDZ hexamethyldisilazane
MWCNT multi-walled carbon nanotubes
Pa Pascals
PDMS polydimethylsiloxane
PHMS poly(hydrogenmethylsiloxane)
ppm parts per million
Pt Platinum
SWCNT single walled carbon nanotubes
wt. % weight percent

Hydrosilylation-cure silicone can be formulated to exhibit thixotropic behavior that allows for the formation of self-supporting structures and can be cured in place under thermal stimulus. According to one embodiment, a silicone-based ink includes an electrically conductive multimaterial filler that is used to form self-supporting structure having electrically conductive silicone-based material. The silicone-based formulation having electrically conductive multimaterial filler results in an elastomer material that may have variable electrical conductivity. According to various approaches, a multimaterial filler may overcome some percolative path constraints for printing a conductive silicone-based ink. Preferably, the multimaterial filler includes a plurality of conductive particles and a fiber-based filler. Moreover, the composition of the silicone-based formulation having electrically conductive multimaterial filler is printable using DIW to form a self-supporting structure. In preferred approaches, silicone-based structure formed with the composition of silicone matrix and electrically conductive multimaterial filler has a high tensile strength (e.g., greater than 4 MPa).

According to one embodiment, a multimaterial silicone-based 3D structure is electrically conductive and has mechanical properties and compression set properties known for elastomeric structures. The electrically conductive multimaterial filler included in the silicone-based material of the structure defines the electrical conductivity of the structure. In one approach, a multimaterial filler may include a combination of a conductive particles and a fiber-based filler. In a preferred approach, the conductive particles include silver-coated particles. In other approach, the conductive particles may be particles that include gold, copper, etc.

In some approaches, the multimaterial filler includes a fiber-based filler that includes a plurality of fibers having an aspect ratio (i.e., aspect ratio=length/diameter) greater than about 10, greater than 20, greater than 100, etc. The product may have a single one of the fillers, or a mixture of the fillers. In some approaches, the fiber-based filler may include single-walled carbon nanotubes (SWCNT), multi-walled CNTs (MWCNTs), conductive nanowires, carbon nanowires, etc. In one example, addition of conductive fiber-based filler, such as carbon nanotubes (CNT), may function in part to bridge gaps between the Ag-coated particles to overcome some of the percolative thresholds. Without wishing to be bound by any theory, it is believed that shear alignment of CNTs in the ink during extrusion in the direction of extrusion promotes the formation of a highly conductive self-supporting structure. Similar silicone-based ink formulation that include high amounts of conductive silver-coated particles (about 70 wt. %) as the only conductive filler may cause the ink formulation to be a solid, non-flowing ink.

In various approaches, a silicone-based matrix material includes an electrically conductive multimaterial filler that may be tuned to a desired resistance characteristic. In some approaches, an amount of multimaterial filler in the silicone-based ink formulation may result in a predefined resistance characteristics, such as, a structure having a predefined resistivity, the area of a region having a predefined measured resistance, etc. In one example, an elastomeric material that includes Ag-coated particles as the electrically conductive filler such that no fiber-based filler is included may be characterized by having a high resistivity (e.g., in one formed bulk structure, a resistivity greater than 50 MΩ). Addition of a fiber-based filler to the Ag-coated particles in the silicone-based formulation increases the electrical conductivity of the material b lowering the measured resistance. A combination of the Ag-coated particles with the fiber-based filler results in an electrically conductive elastomer material characterized as having a low resistivity. Without wishing to be bound by any theory, it is believed that the fiber-based filler forms bridges to connect the conductive silver particles and possibly separate particles from the siloxane matrix.

It was surprising that addition of high aspect ratio fiber filler, such as CNTs, creates a significant drop in resistivity in the silicone-Ag material. Addition of an increasing amount of CNTs (0.25 wt. %, 0.5 wt. %, 1.0 wt. %, etc.) to a silver particle-silicone formulation does not have a linear additive effect of increasing electrical conductivity (as determined by measuring resistance of the product). With increasing amounts of CNTs, from greater than 0 wt. % to 1 wt. % of the ink formulation, the magnitude of resistivity drops 50 to 100 fold from a silicone ink formulation that includes only Ag-coated particles.

According to one embodiment, the loading of silver in the silicone ink may be below the percolation threshold that will achieve conductivity, such that dielectric layers of highly resistive silicone between conductive particles restricts charge transports. The amount of silver may be a minimum concentration of a conductive filler within an insulating ink needed to support conductivity. In sharp contrast, embodiments described herein include fiber-based filler (e.g., CNTs) which mix into the silicone matrix between the conductive metal fillers (e.g., Ag-coated particles), and thus, a highly dielectric pathway is replaced by a more resistive pathway, and the material may reach percolation or, alternatively, behave as a resistive partially percolated network instead of a dielectric partially percolative network.

According to various embodiments, a three-dimensional (3D) structure may be formed using an ink formulation that demonstrates printability of self-supporting porous architectures using an additive manufacturing (AM) technique. According to one embodiment, a product of AM with a multimaterial silicone-based ink includes a printed 3D structure that includes filaments in a predefined geometric arrangement, where the filaments include a silicone-based matrix and a multimaterial filler. The printed 3D structure may be configured to have a predefined electrical resistance characteristic where the electrical resistance characteristic is a function on the predefined geometric arrangement of the filaments. In one approach, the structure has a predefined electrical resistance characteristic between predefined points on the structure itself that are located more than two filaments apart as opposed to a resistance characteristic that is simply within a single filament, or a simple resistivity of the cured ink itself. For example, a bulk structure of similar material would not have the electrical resistance characteristic. An electrical resistance characteristics may be defined as a measured resistance per unit length of a structure. The electrical resistance is measured using probes attached at the distal ends of the length of the portion of the structure. In various approaches, the predefined electrical resistance characteristic may be configurable based on a print architecture. For example, application of strain on a printed 3D structure may provide a desired electrical property that is not present in the structure in an unstrained state.

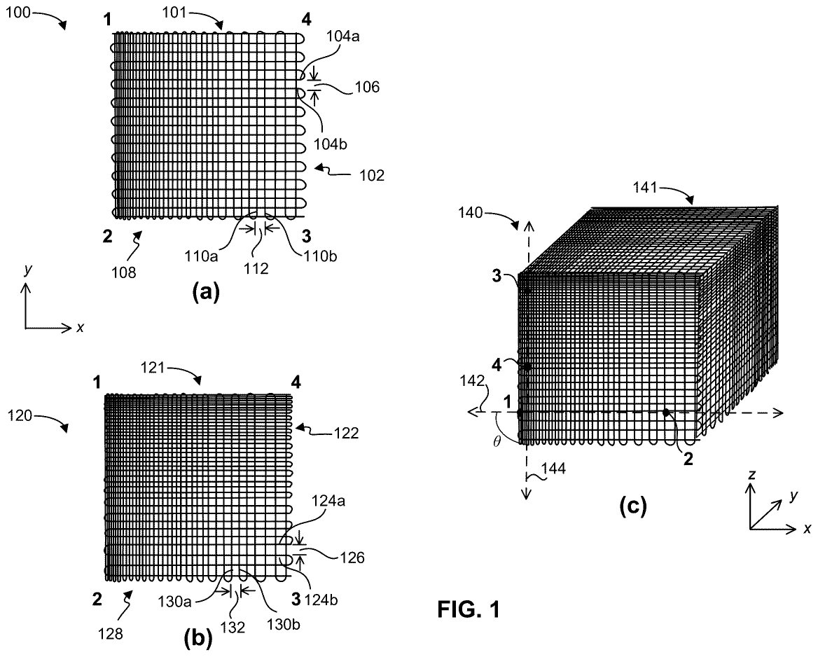

FIG. 1 depicts a schematic diagrams of products 100, 120, and 140 in accordance with various embodiments. As an option, the present products 100, 120, and 140 may be implemented in conjunction with features from any other inventive concept listed herein, such as those described with reference to the other FIGS. Of course, however, such products 100, 120, and 140 and others presented herein may be used in various applications and/or in permutations which may or may not be specifically described in the illustrative embodiments listed herein. Further, the products 100, 120, and 140 presented herein may be used in any desired environment.

In one approach, a structure may be characterized by regions having different density defined by the predefined geometric arrangement of filaments. In one approach, a density of a region of structure may be defined by an arrangement of filaments of which a distance between adjacent filaments is variable and adjacent filaments have a similar average diameter. As the distance between adjacent filaments increase, the density of conductive material of the structure decreases. Alternatively, as the distance between adjacent filaments decreases, the density of conductive material of the structure increases. In one example, a gradient of density may be controlled by a predefined toolpath for extrusion printing of a filament to form an arrangement of filaments characterized by a change in the distance between adjacent filaments.

In some approaches, a printed structure may have a gradient of porosity as characterized by an increase in void space in the printed structure. A geometric arrangement of filaments (e.g., features, strands, beads, ligaments, etc.) may be configured to have a predefined distance between adjacent filaments where the predefined distance changes across a length of the printed structure. A region of the printed structure having smaller distances between filaments may have a lower porosity and as distances between adjacent filaments increase, the porosity of the structure increases. Porosity is the percentage of empty space in a material, and is calculated by dividing the volume of voids by the total volume of the structure. The volume of the structure may be calculated using the outer dimensions of the structure, length l, width w, and depth d. The volume of the voids of a structure may be calculated according to the average diameter, length, and geometric arrangement of the filaments that define the voids of the structure (e.g., the space between the filaments).

Examples of silicone structures printed using DIW techniques are illustrated in the schematic drawings of FIG. 1. Part (a) depicts one example of a top down two-dimensional (2D) view of a product 100 having a printed electrically conductive structure 101 having gradient of density of conductive material. As illustrated in the structure 101 includes a first layer 102 having filaments 104a, 104b that have about equal distance 106 between adjacent filaments 104a, 104b across a length of the structure from point 1 to point 2. In one example, a second layer 108 is characterized by a gradient of density of conductive material where with filaments 110a, 110b have a stepwise increase in distance 112 between adjacent filaments 110a, 110b along the length of the structure from point 2 toward point 3. The filaments are formed by extrusion through a nozzle and have a similar average diameter throughout the structure. In various approaches, a structure may be characterized as having a predefined gradient of porosity across the entire structure in one direction (e.g., x-direction, y-direction), in two directions (e.g., x-y plane), etc. In one approach, a predefined gradient of porosity may be configured so that an application of strain on the structure may give a desired electrical property that is not present in the structure in an unstrained state.

In various approaches, a gradient increase of porosity is characterized by an increase in distance between adjacent filaments in a layer of the structure. In one approach, filaments may be positioned in parallel relative to each other and parallel to an x-y plane of the structure. A step-wise increase in distance between adjacent filaments may in one direction (e.g., x-direction, y-direction) thereby resulting in a gradient of porosity in one direction (e.g., x-direction). For example, structure 101 illustrates in the second layer 108, an increase in distance 112 between adjacent filaments 110a, 110b in a geometric arrangement of the parallel adjacent filaments 110a, 110b from point 2 to point 3 thereby resulting in a gradient in porosity in the x-direction along a region of the structure 101.

According to one embodiment, the structure may be characterized by regions having a different electrical resistance characteristic based on print architecture. In one approach, a change in resistance between regions may depend upon the density of at least two respective regions that have densities based on a print architecture. In one approach the electrical resistance characteristic of a region of a structure corresponds to the porosity of the region. The electrical resistance of a region of a structure may correspond to the density of electrically conductive material in the region. In one approach, a structure having defined regions may have an electrical resistance in one region that is lower relative to an electrical resistance in a second region. For example, structure 101 has a region between point 1 and point 2 that has a lower electrical resistance (i.e., higher electrical conductivity) compared to a region between point 3 and point 4 that has a higher electrical resistance (i.e., lower electrical conductance). A measured resistance R between two distal ends of the region is equal to the resistivity p of a region times the length l of the region divided by the cross-sectional area A of the region, see Equation 1. The resistivity ρ value is maintained during stretching, compressing, bending, etc. of the print structure as area A and length l are modified over time.

$$R = ρ \frac{l}{A} \qquad Equation 1$$

In another approach, the gradient change in spacing between printed filaments positioned parallel in an x-y plane thereby resulting in a gradient of porosity is along the y-direction. The gradient change may be an increase in spacing between the filaments extending over the entire length of the part, a decrease in spacing between the filaments extending over the entire length of the part, an alternating pattern of increasing and decreasing of spacing for predefined portions of the part, etc.

In one approach, a structure may be characterized by a change in resistance that is dependent on the predefined pattern of spacing between the printed filaments. In one approach, a structure may be characterized by a change in resistance that is dependent on contacts between reference points across the structure. For example, as illustrated in product 100 of part (a), contact points 1, 2, 3, and 4 of structure 101 may have a change of resistance between the points as measured by probes connected to at least two contact point, such as a change in resistance between contact point 1 and contact point 2, a change in resistance between contact point 2 and contact point 3, a change in resistance between contact point 1 and contact point 3, etc.

Part (b) of FIG. 1 is a schematic drawing of one example showing a top down 2D view of a product 120 that includes a printed conductive structure 121 having a gradient of density of conductive material in at least two directions. For example, the structure 121 has an decreasing gradient of density of electrically conductive material in an y-direction as evidenced by an increase in distance 126 between adjacent filaments 124a, 124b comprising the electrically conductive material in a first layer 122 from point 1 to point 2, and the structure 121 has a decreasing gradient of density of electrically conductive material in an x-direction as evidenced by an increase in distance 132 between adjacent filaments 130a, 130b comprising the electrically conductive material in a second layer 128 from point 2 to point 3.

The gradient of density may be controlled by a predefined toolpath for extrusion printing of a filament to form filaments (strands, ligaments, features, etc.) having a change in distance between the filament for each of the printed layers. The change in density of each layer based on the geometric arrangement of the filaments may result in a gradient of porosity in the structure in one direction (e.g., x-direction, y-direction), in two directions (along x-y plane). In one approach, a gradient of porosity in a first layer of a structure may be the same as the gradient of porosity in a second layer of the structure. In another approach, gradient of porosity in a first layer of a structure may be different than a gradient of porosity in the second layer of the structure. In various approaches, the gradient of porosity may correspond to a gradient of measured resistance in a structure between two reference points. In one approach, an increase in porosity in a region of a structure corresponds to an increase in measured resistance between two references points.

In one approach, a 3D structure has a geometric arrangement of filaments in an x-direction, y-direction, and z-direction, the z-direction being orthogonal to the x-y plane of a 3D structure, and the structure may be configured to have a gradient of measured resistance in at least one direction across the structure that corresponds to a gradient of porosity. In one approach, the gradient of measured resistance is in at least one direction between two reference points in a plane of the structure, e.g., the plane may be an x-y plane, a x-z plane, a y-z plane.

As an example, part (c) of FIG. 1 illustrates a product 140 that includes a cube-like 3D structure 141 having a gradient of density of electrically conductive material in the x-direction, the y-direction, and the z-direction. A toolpath may be predefined to form a 3D structure having variation of distance between the extruded filaments that forms structure having a gradient of density of electrically conductive material. Various 3D structures having customized pore architecture include a cube, a prism, a cylinder, a hollow cylinder with gradient porosity of the walls of the cylinder, a 3D structure having lattice geometries, etc. In one example, a spiral structure has a change in spacing in the loop in the spiral that forms a gradient porosity.

According to one approach, a predefined gradient of porosity may be a gradient in at least one direction such as an x-direction, a y-direction, a z-direction, across an x-y plane, across an x-z plane, across a y-z plane, or a combination thereof. This also encompasses structures that have a gradient primarily at an angle from any of the aforementioned directions and/or planes, which would exhibit a gradient along two or more of the aforementioned directions and/or planes.

In some approaches of a 3D conductive silicone structure, a structure may have a predefined print architecture that has print regions with discrete differences in porosity. For example, one side of the 3D structure may have 50% porosity, and a different side of the 3D structure may have 0% porosity.

In one approach, as illustrated in part (c), the structure 141 may be characterized by exhibiting a different average electrical resistance per unit length between first 1 and second 2 reference points on the structure 141 than between third 3 and fourth 4 reference points that are on a second imaginary line 144 aligned at an angle θ greater than 0° up to 90° from a first imaginary line 142 that intersects the first 1 and second 2 reference points. For example, structure 141 has a measured electrical resistance per unit length between point 1 and point 2 that is different than the measured electrical resistance per unit length between point 3 and point 4.

In one approach, a DIW technique allows fabrication of porous 3D structures that have a porosity tuned by predefined spacing and predefined diameters of adjacent filaments formed during extrusion of the filaments during printing. Moreover, according to various approaches, the process allows introduction of anisotropic conduction using print toolpath design. The conductive function of the printed material may be tuned to have a gradient of electrical conduction across the printed part. The gradient of electrical conduction may be configured in different aspects of the x-y plane. For example, along the x-axis, along the y-axis, diagonal across the x-y plane, etc. In one approach, electrical conductance is not uniform across the part. In another approach, the electrical conductance is uniform across the part in one direction.

A gradient of porosity in a part results in a gradient of density of electrically conductive material that affects the measured resistance across the part. Printing a part with gradient porosity as described results in a gradient of measured resistance between reference points of the part. For example, looking back to part (a) of FIG. 1, a gradient of conductance may be demonstrated by greater conductance in the region between points 1 and 2 where the distance between the adjacent filaments is the smallest and this portion of the part has the greatest density. Electrical conductance of the part decreases as the distance between adjacent filaments increases. The least dense region of the part having the largest distance between adjacent filaments, e.g., between points 3 and 4 of structure 101, the electrical conductance is the lowest corresponding to a relatively high measured resistance in this region of the structure.

Moreover, according to one embodiment, a gradient of density that results in a gradual change in density of electrically conductive material (e.g., by increasing or decreasing the distance between adjacent filaments in the structure) results in a directionality of conductivity in the structure. In another approach, discrete regions having a predefined density may be printed that result in multiple regions having different densities. The discrete regions of density may not be a gradient of density. In one approach, controlling the extrusion toolpath of a multimaterial strand for forming a 3D structure results in a predefined region, direction, etc. of conductance in the formed 3D structure. In one approach, a 3D structure is formed with a predefined path, direction, etc. of an electrical signal through the 3D structure.

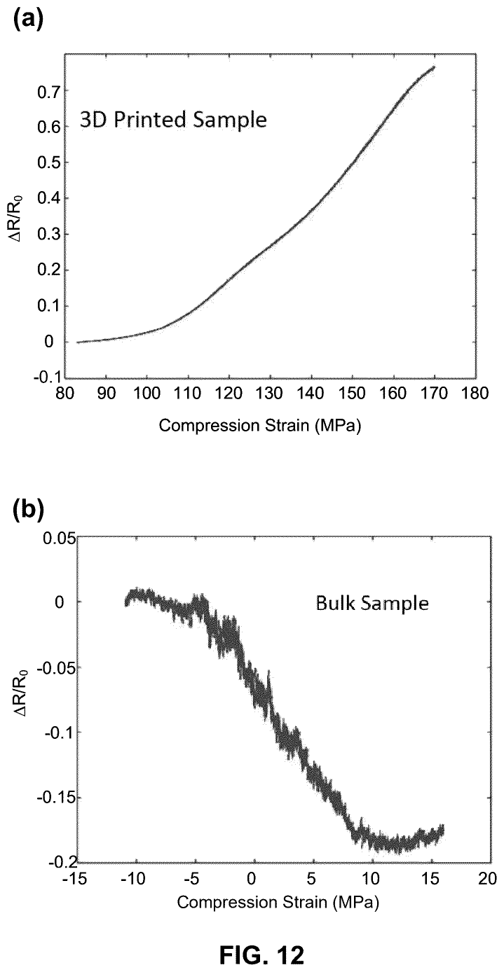

According to one embodiment, a printed 3D structure is resiliently deformable (e.g., pliable, elastomeric, etc.) and may exhibit a change in resistance in a portion of the structure subjected to strain. The applied strain may include compression of the structure, bending the structure, stretching the structure, etc. For example, the 3D structure has a predefined geometric arrangement of filaments where the filaments are a comprised of a silicone material and multimaterial filler where the structure has a predefined measured resistance. Upon application of compression strain on the 3D structure, the structure may demonstrate an increase in resistance (see part (a) of FIG. 12).

The physical properties of structures formed with silicone matrix having varying amounts of multimaterial demonstrate that the pliable nature of the silicone material is not significantly affected by the presence of the electrically conductive multimaterial filler. In some approaches, conductive additives may be added to the silicone matrix that may not have any influence mechanical properties of the silicone matrix, such as liquid metal particles. In other approaches, conductive additives may have some effect on the mechanical properties of the silicone matrix. For example, structure formed with electrically conductive multimaterial such as silver particles (e.g., Ag-coated Al particles) and high aspect ratio filler (e.g., SWCNTs) demonstrate a tensile strength above 4 MPa. An increasing amount of conductive particles in the silicone matrix causes a decrease in elongation properties of the material. However, the physical characteristic of elongation of the part is increased in the presence of 20 wt. % Ag-coated Al particles. The measured secant modulus of silicone parts printed with varying amounts

of multimaterial filler demonstrate an increase in 25% secant modulus corresponding to an increase in multimaterial filler. Durometer measurements of silicone parts formed with varying amount of multimaterial filler demonstrate an increase in Shore A measurements from a mid-50 measurement up to mid-60 measurement thereby demonstrating that the addition of rigid electrically conductive fillers cause an increase in Shore A measurements of the part. Compression set testing of various silicone parts formed with electrically conductive multimaterial filler demonstrate an increase from about 5% compression set up to about 15% compression set with increasing amounts of electrically conductive multimaterial filler. The presence of the electrically conductive multimaterial filler may not significantly adversely affect the pliable physical characteristics of the silicone material.

Moreover, a printed 3D structure may have physical characteristics such as mechanical properties and compression set of the materials that is maintained with loading of a multimaterial filler that includes up to 60 wt % Al/Ag and 0.65 wt % SWCNT. At loadings above these mass percentages, an ink rheology may not be amenable to printing and the material may experience a large compression set.

In various approaches, 3D printed architecture provides a measured resistance in response to strain. In one approach, application of tensile strain to a 3D printed sheet of silicone matrix and electrically conductive multimaterial filler demonstrates an increase in electrical resistance with increasing strain. In one approach, addition of a multimaterial filler (e.g., Ag-coated Al particles and SWCNTs) to a silicone matrix formulation to form a printed sheet results in the printed sheet having a remarkable increase in resistance in response to tensile strain compared to a sheet printed with a silicone formulation that includes a fiber-based filler (e.g., SWCNTs).

Moreover, in some approaches, a 3D printed architecture provides measured resistance in response to compressive strain. For example, a lattice structure having filaments arranged to form a defined porosity has electrical resistance variation in response to compressive strain. The architecture of the printed structure may be tuned to generate a controlled electrical resistance. In addition, the materials of the printed product maintain mechanical properties and compression set. The composition using reinforced silica as described herein forms a percolating conductive structure having high tensile strength, greater than 4 MPa.

According to one embodiment, a silicone-based formulation that includes a multimaterial filler, such as CNTs, Ag/Al, etc. forms a structure that is characterized as having a measurable, repeatable value of resistance during multiple cycles of strain. In one example, a silicone sample having CNTs demonstrates reproducible resistivity between cycles of 0% and 25% strain.

In one embodiment, a structure may include non-conductive filaments, formed with a similar silicone-based formulation without electrically conductive multimaterial filler, that define placement of electrically conductive filaments comprising the silicone-based matrix and multimaterial filler in the predefined geometric arrangement of filaments. In one approach, electrically conductive filaments of a structure may provide at least one electrically conductive trace according to a predefined path across at least a portion of the structure.

According to one embodiment, a predefined printed structure may be an electrically conductive substrate for additional features included in a product. In one approach, a structure may be printed directly onto conductive pads for forming connections between the conductive pads, e.g., to facilitate sensing. For example, a printed circuit board may include conductive pads (e.g., copper), and then a conductive silicone structure is printed between the two conductive copper pads. The resulting printed circuit board includes the hardware to measure the change in electrical resistance and the printed conductive silicone makes the connection between the conductive pads allows the sensing response to be measured. In one embodiment, a predefined printed structure is a self-standing structure having a silicone based matrix and electrically conductive multimaterial filler. In one approach, the 3D printing process allow formation of self-supporting structures that use architecture for novel conductive responsivity. In one approach, a product includes two features defining a gap therebetween, where the structure is a free-standing structure that spans the gap, such that the structure is not supported across the gap.

In another embodiment, the product is a conductive adhesive material positioned between two conductive interfaces. In one approach, a bonding electrical connections may be formed by depositing conductive silicone matrix directly onto a conductive material to form a secure connection with a different conductive component.

### A Strain Sensor

In one embodiment, the product may include a strain sensor configured to detect a change in measured resistance of the structure upon deformation of the structure caused by an exertion of strain thereon. The strain may include compression, bending, stretching, elongation, etc. The formulation of the multimaterial fillers in the silicone-based ink may control the sensor response. The formulation of the bulk material may be tuned to control the potential strain response of resistance. For example, stretching the formed structure results in a change in resistance.

According to various approaches, a printed structure may have a resistance characteristic where the measured resistance is determined based on the orientation of the geometrically arranged filaments. In one approach, a geometric arrangement of filaments may demonstrate a different electrical resistance measurement depending on the orientation of the arrangement. For example, a measured electrical resistance of a region may be changed by one of the following: 1) rotating a structure to a different orientation and applying strain in a different direction, 2) positioning probes on the structure for the resistance measurement at locations that have different densities, 3) printing a structure having a complex geometries with a predefined orientation. According to various approaches, a 3D printed structure may be rotated to change the measured electrical resistance of a specific region. For example, referring to a 2D orientation in an xy plane, a sample may have a defined orientation to generate a specific electrical response to strain. In some approaches, a 3D structure may also have a defined orientation in the z-direction such that the structure has a 3D directional electrical response to strain.

### A Laser Etched Path of Conductivity

A 3D structure of silicone and electrically conductive multimaterial filler may have a skin layer on the surface of the structure that has lower electrical conductivity than the electrical conductivity of the bulk of the 3D structure. In one embodiment, laser etching (e.g., engraving, sintering, etc.) may be used to ablate, melt, remove, etc. layers from a bulk solid. In one approach, conductivity enhancement at laser processed interfaces may be achieved by removal of polymer skin layers. This exposes conductive carbon/metal and removes insulating silicone in the process. In contrast, laser etching may not be limited to sintering the surface of the structure.

Sintering is the fusing and consolidation of powdered materials (metals, ceramics, some polymers, etc.) into bulk or near-bulk solids. Here, a bulk solid is described as a fully dense material without volumetric or surface porosity. In contrast, a near-bulk material will exhibit porosity, voids, or incomplete consolidation. A fully dense structure without porosity will exhibit higher conductivity than a near-bulk sintered material. Sintering is accomplished through the application of heat, pressure, or both without having to achieve a liquid melt. Particles can be laser sintered as a result of the energy imparted from the laser thereby contributing to conductive networks. In the 3D structure, the silicone matrix having the multimaterial filler is already formed. Thus, without wishing to be bound by any theory, it is believed that the etching process may carbonize the polymer, and thus additional carbon in the presence of the filler results in a less resistive path.

In one approach, a portion of a surface of a printed structure may have physical characteristics of being sintered by laser etching. In one approach, a portion of a surface of a printed structure may have its physical electrical characteristics modified by laser etching. The portion can be the whole surface, could be a fraction of the surface, could be in discrete portions on the surface, a pattern, etc.

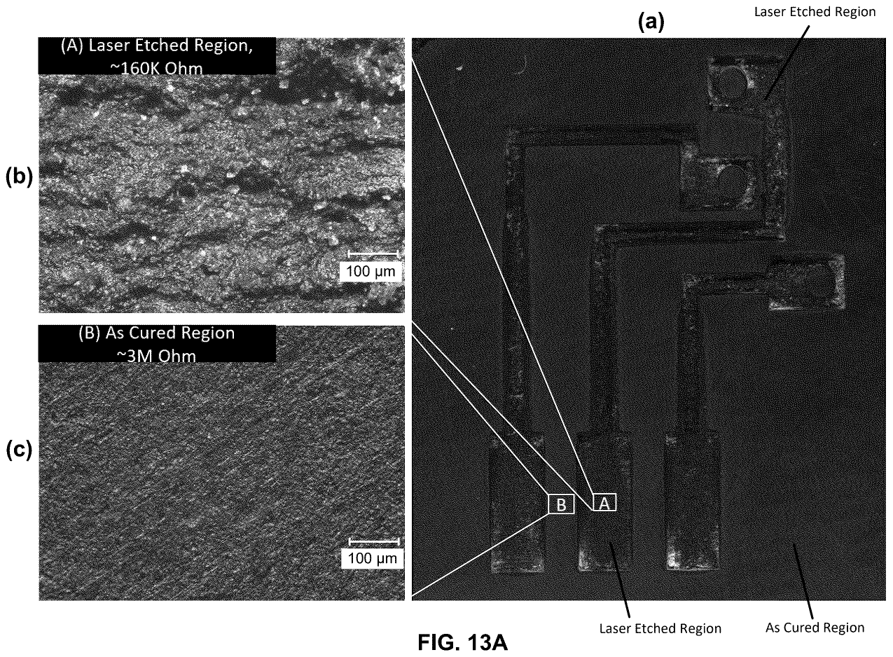

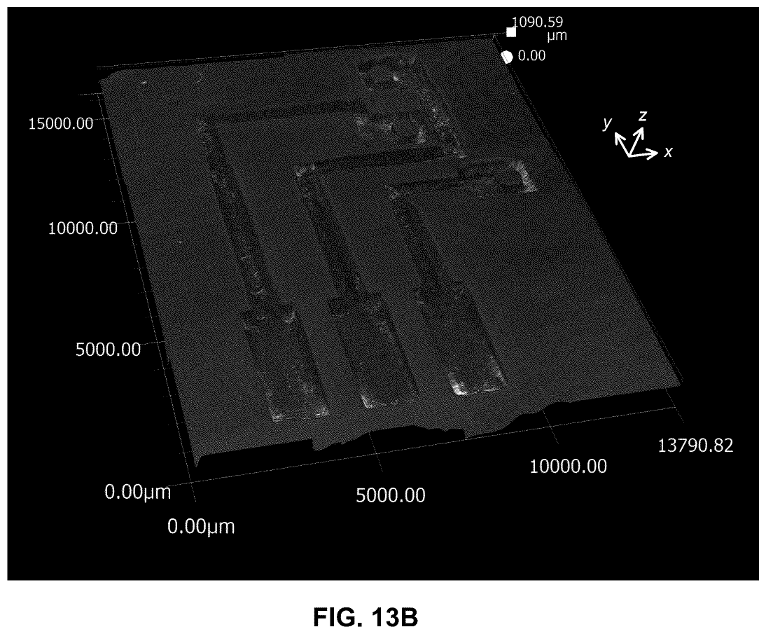

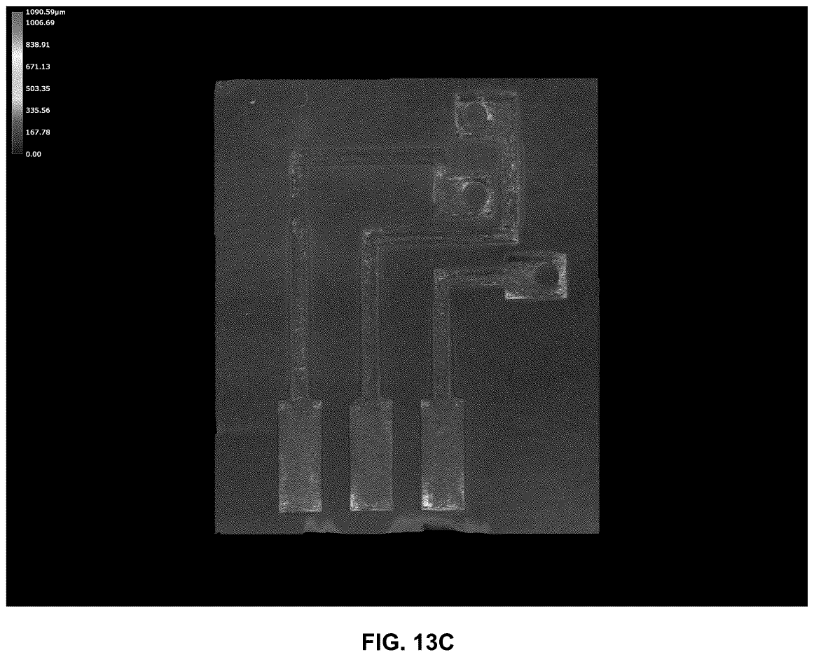

In one approach, an entire area of the engraved portion of the surface of the structure is smaller than an entire area of the surface (for example, see FIGS. 13A-13C). The engraved portion corresponds to the etched portion of the surface of the structure. In an exemplary approach, a surface of a printed and cured 3D structure may have an etched surface (e.g., using laser etching) thereby resulting in increased electrical conductivity at the material surface of the structure.

According to one embodiment, a surface of a formed silicone 3D structure may be etched, engraved, etc. to define a path of conductivity (e.g., an electrical signal) through the 3D structure. In one approach, conductivity of the structure may be increased by using laser etching, engraving, etc. at the material surface. A skin layer on a printed silicone structure may affect the surface resistivity of the part. The surface of a printed part demonstrates a sheet resistance between two reference points, sheet resistivity, etc.; and following a laser etch of the surface of the silicone part, the etched surface of the silicone exposes electrically conductive filler material. Etching a surface of the silicone structure may demonstrate a significant enhancement of surface electrical conductivity. For example, cutting a cross section in the material and measuring the resistivity at the cut may likely demonstrate a lower resistivity compared to the cured surface layer (i.e., skin layer).

In one approach, an etched silicone surface of a conductive structure may have a lower surface resistivity which may be useful for electrical bonding the elastomeric conductive printed material to an adjacent metal object. Moreover, in some approaches, laser etched surfaces may be plated with conductive material (e.g., bath, ink, etc.) for local conductivity enhancement, passivation, etc. In some approaches, a laser etching method may overcome some of the surface effects of high conductivity associated with silicone and promote an accessible electrical function. In one approach, electroless plating onto a silicone may further enhance further electrical conductivity.

In one embodiment, a product may include an uncured multimaterial silicone material that provides electrical conductivity at the sintered portion (e.g., etched portion) on the surface of the structure. In one approach, a printed 3D structure has an etched surface, and on the etched surface, a pattern of uncured multimaterial silicone material is positioned at the location of the etched surface. For example, good electrical connections on a structure may be constructed by incorporating an electrically conductive uncured material (e.g., an uncured resin) to an etched portion of the structure. A potential application may include an uncured material associated with the cured silicone structure for better electrical connections. The uncured material may have the same formulation as the cured material of the structure; the uncured material is positioned onto a surface of the cured structure thereby forming an improved electrical connection on the electrically conductive silicone structure.

### Heating Element or Temperature Sensor

According to one embodiment, a product that is tuned for electrical resistance along a path may be used as a heating element. A tuned path of resistivity, or the resistance, in a 3D structure allows a tuned amount of current to pass through the structure. One application of the structure having a tuned path of resistivity is to use the structure as a heating element. In some approaches, a silicone-based 3D structure may be used as a heating element for use at temperatures above −100° C. up to about 300° C. In preferred approaches, a silicone-based 3D structure with a tuned path of resistivity may be used as a heating element for use at temperatures in a range of about 25° up to about 200° C. In some approaches, the heating element may generate a heating gradient according to the path of resistivity.

In another approach, the silicone-based 3D structure may function as a temperature sensor with directionality where a coefficient thermal resistivity may detect a change in resistance that may be function of temperature.

### Process for Forming an Electrically Conductive 3D Structure Using a Multimaterial Silicone-Based Ink

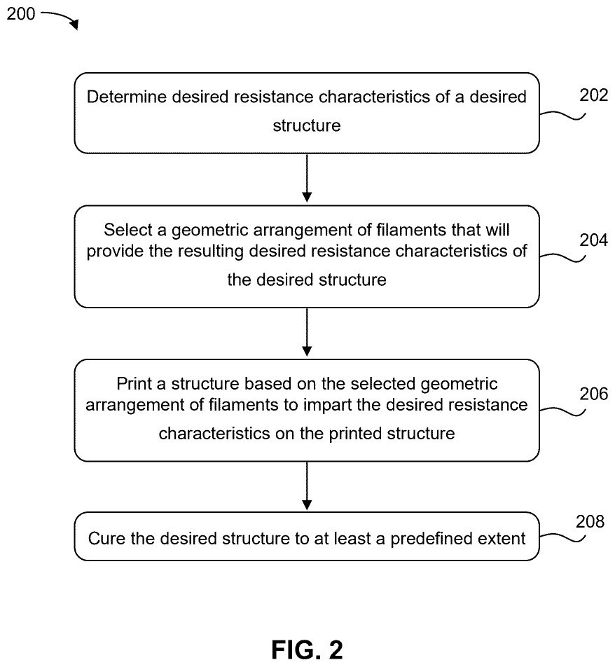

FIG. 2 shows a method 200 for forming an electrically conductive three-dimensional structure using a multimaterial silicone-based ink, in accordance with one embodiment. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative embodiments listed herein. Further, the methods presented herein may be carried out in any desired environment. Moreover, greater or fewer operations than those shown in FIG. 2 may be included in method 200, according to various embodiments. It should also be noted that any of the aforementioned features may be used in any of the embodiments described in accordance with the various methods.

According to one embodiment, the method 200 may being with step 202 involving determining a desired resistance characteristic of a desired structure. In one approach, the desired resistance characteristic may be defined according to a desired resistance between two contact points in a defined region of a desired 3D printed structure. For example, a desired resistance characteristic is a low measured resistance in one region of desired 3D structure (i.e., high conductance) with increasing measured resistance in one direction across the desired 3D structure.

Step 204 of method 200 includes selecting a geometric arrangement of filaments that will provide the resulting desired resistance characteristics of the desired structure. In one approach, additive manufacturing techniques such as DIW use a predefined toolpath for extrusion of filaments having a predefined distance between extruded filaments for forming a porous 3D structure. For example, a predefined toolpath may be selected for extrusion printing of a filament to form an arrangement of filaments characterized by a change in the distance between adjacent filaments that would thereby result in a gradient of density and subsequently a gradient of measured resistance across a region of the printed structure.

In various approaches, a selected predefined arrangement of filaments may include fabrication of a lattice-type structure, a cylinder, a cube, a prism, a hollow cylinder having walls of graded porosity, etc. Each shape formed by the arrangement of filaments may include a gradient of porosity that is defined by the predefined arrangement of filaments having an increasing distance between adjacent filaments.

According to one approach, complex geometries may be printed that allow for variable response of the electrical signal depending on the direction specified by a predefined toolpath and then depending on the strain applied in the specified direction.

Step 206 of method 200 includes printing the desired structure based on the selected geometric arrangement of filaments to impart the desired resistance characteristics on the printed structure. The desired resistance characteristic is predefined and different than a resistance characteristic of a printed structure acquired after printing a bulk structure. For example, a resistance characteristic may include a graded measured resistance in a region of the printed structure that is different than a graded measured resistance in a different region of the printed structure.

Step 206 includes using a silicone-based ink having electrically conductive multimaterial filler to print the desired structure. The silicone-based ink preferably includes a multimaterial filler that is a combination of conductive particles and fiber-based filler. The product may have a single one of the fillers, or a mixture of the fillers. In some approaches, fiber-based filler may include high aspect ratio fibers (i.e., aspect ratio =length(l)/diameter(d)). In some approaches, preferably, a high aspect ratio fiber may include a plurality of fibers having an aspect ratio greater than about 10 (l/d). In one approach, a high aspect ratio fiber may include a plurality of fibers having an aspect ratio greater than about 5 (l/d). In one approach, a high aspect ratio fiber may include a plurality of fibers having an aspect ratio greater than about 20 (l/d). In another approach, a high aspect ratio fiber may include a plurality of fibers having an aspect ratio greater than about 50 (l/d). In some approaches, a high aspect ratio fiber may include a plurality of fibers having an aspect ratio greater than about 100 (l/d). For example, high aspect ratio fiber-based fillers include SWCNTs, multi-walled CNTs (MWCNTs), carbon nanofibers, carbon spheres (e.g., fullerene), carbon platelets, conductive nanowires (e.g., silver nanowires, gold nanowires, etc.). In an exemplary approach, the CNTs are single-walled CNTs (SWCNTs).

In some approaches, the multimaterial filler includes a plurality of conductive particles that include silver-coated particles. In other approaches, a plurality of conductive particles includes gold-coated particles, copper-coated particles, etc. In various approaches, the plurality of conductive particles include a core material being a metal, a ceramic, an inorganic, etc.

In one approach, the silicone-based ink formulation includes a loading of multimaterial filler that includes silver-coated aluminum (Al/Ag) up to 60 wt. % with some smaller loading of high-aspect ratio single-walled carbon nanotubes (SWCNT) up to 1 wt. % to establish a conductive network. The combination of Al/Ag and SWCNT provides a loading of filler to form a percolating conductive network. The combination counters the typically necessary loading of 70 wt % Al/Ag for a percolating conductive network which unfortunately forms a solid, non-flowing mixture. At lower loadings with combination filler systems, conductivity may be achieved, and rheological properties are maintained making the ink amenable to casting or extrusion methods such DIW printing.

In some approaches, step 206 may include adding to the mixture, in the cartridge, a curing agent and/or a crosslinking agent. Alternatively, the curing agent and/or crosslinking agent may be part of a premade mixture that is fed through the cartridge. In this and other embodiments, the cartridge may be a nozzle. The mixture may be formed in the nozzle, where one or more of the components is added to the nozzle separately from the other components. A mixer may provide mixing within the nozzle. In another approach, the mixture may be premade and fed to the nozzle.

The silver component of the ink formulation functions to inhibit curing thereby removing a need for a crosslinking inhibitor component in the siloxane ink. In some approaches, a siloxane ink formulation having higher loading of silver (e.g., loadings of silver in a range of greater than 20 wt. % Ag-coated Al particles) does not include a crosslinking inhibitor.

For printing using DIW, step 206 includes extruding the mixture through the cartridge to form a 3D structure. In various approaches, the presence of a rheology modifying additive imparts pseudoplasticity to the silicone-based ink such that the compression stress of the ink in the cartridge allows the ink to be extruded from the cartridge during 3D printing. The printed 3D structure is a self-supporting 3D structure.

In some approaches, the product of additive manufacturing with silicone-based ink may have features (e.g., filaments, strands, ligaments, etc.) about 100 μm or larger. Based on the ink viscosity smaller features may be created below 100 μm. In some embodiments, the product may have dimensional stability. In other words, the structure formed following 3D printing with silicone-based inks may retain pre-defined dimensions following curing of the structure, for example, there is minimal shrinkage.

Step 208 of method 200 includes curing the desired structure to at least a predefined extent. In one approach, the curing may occur during printing. In another approach, the curing may occur after the structure is printed. In various approaches, the 3D printed structure of silicone-based ink may be cured according to the curing agent present in the silicone-based ink. In some approaches, the temperature may be raised in order to initiate curing. In other approaches, UV irradiation may be used to initiate curing of the printed structure. In yet other approaches, free radical chemistry may be used to initiate curing of the printed structure. In various other approaches, curing may be initiated by methods known by one skilled in the art.

A Silicone-Based Ink with a Multimaterial Filler

In one embodiment, a formulation of a silicone-based ink comprising an electrically conductive multimaterial filler includes a vinyl-terminated siloxane macromer, a hydrophobic reinforcing filler, a rheology modifying additive, conductive particles, and a high-aspect ratio fiber-based filler, a curing agent, and a crosslinking agent. According to various approaches, the silicone-based ink is based on the silicone formulation described in U.S. Pat. No. 10,689,491, herein incorporated by reference.

In one embodiment, a formulation for the silicone-based ink for DIW includes a vinyl-terminated siloxane macromer, a hydrophobic reinforcing filler, and a rheology modifying additive. In some approaches, the vinyl-terminated siloxane macromer may be an oligomeric organosiloxane macromer, a polymeric organosiloxane macromer, a vinyl-terminated polydimethylsiloxane (PDMS) macromer, a vinyl-terminated polydimethylsiloxane-diphenyl siloxane (DPS) macromer, etc. In some approaches, the vinyl-terminated siloxane macromer may have a viscosity in a range of about 500 centiStoke and about 50,000 centiStoke (cSt).

The hydrophobic reinforcing filler is preferably a silica filler that contributes to thixotropy to give the ink a reversible yield stress. Fumed silica, preferably treated silica, causes the ink to have a storage modulus drop under shear during extrusion as the ink is deposited, and then in the absence of shear, the storage modulus increases, and the deposited ink becomes rigid and self-supporting. In some approaches, the treated fumed silica may have a surface area in a range of about 50 m²/g to about 250 m²/g. In a preferred approach, the treated silica may have a surface area in a range of about 100 m²/g to 200 m²/g for imparting reinforcement while alleviating an increase in viscosity that could obstruct the extrusion process.

In some approaches, the treated silica may be hexamethyldisilazane (HMDZ)-treated silica. In other approaches, additional treated silicas with increased hydrophobicity may also be used. In some approaches, a silicone-based ink may include a composite of PDMS-DPS and hydrophobic filler such as HMDZ-treated silica. The hydrophobic reinforcing filler, such as HMDZ-treated silica, may be included to ensure a long-term stability of 3D printed silicone components prior to curing. HMDZ treatment of silica may involve capping the silanol groups of the silica with HMDZ to yield trimethylsilanes and a hydrophobic filler surface.

In some embodiments, an amount of treated silica in the silicone-based ink may be in a range of about 5 wt. % to about 50 wt. % of total composition of the ink, and preferably in a range of about 12 wt % to about 35 wt. % of total composition of the ink. In some approaches, silica fillers with reduced surface area allow an increase degree of silica loading without over-saturating the liquid ink matrix, and thereby resulting in highly stiff printable silicone materials. In some approaches, the effective concentration of fumed silica may be determined from the surface area of the fumed silica using known techniques.

In some approaches, the ink formulation includes a rheology modifying additive to impart silicone pseudoplasticity and contribute to thixotropy of the ink. In some approaches, the rheology modifying additive may be a silicone polyether, a methylvinyl siloxane (or dimethyl siloxane), dimethoxy (glycidoxypropyl)-terminated, glycerol, 2-propanol, a polyethylene glycol (PEG), or combinations thereof. In some approaches, the silicone-based ink may include a rheology modifying additive in a range of about 0.01 wt. % to about 10.0 wt % of total composition, and preferably about 0.2 wt. % to about 1.0 wt. % of total composition.

In other approaches, a more hydrophilic reinforcing filler such as untreated fumed silica may be incorporated into the silicone-based material to impart thixotropy of the silicone material into solid-like network in the absence of applied stress. The mechanism of pseudoplasticity may be attributed to unreacted silanol groups on the silica surface, thereby allowing for particle associations through hydrogen bonding to form an anti-sagging network exhibiting shape retention behavior.

According to one embodiment, a siloxane ink that includes a multimaterial filler may not adversely affect the pseudoplasticity of a silicone-based ink imparted by the treated silica and rheology modifying additive. In one approach, a multimaterial filler that includes Ag-coated particles and CNTs may not adversely affect the formation of a stable 3D network between treated-silica filler particles and a rheological modifying additive via hydrogen bonding and potential van der Waals interactions. Moreover, the presence of multimaterial fillers may augment the pseudoplasticity of the silicone-based ink. The silicone-based inks described herein are pseudoplastic, non-Newtonian fluids, capable of being deposited in a layer-by-layer pattern during 3D printing.

In various approaches, Ag-coated particles may comprise a core material that does not adversely affect the density of the ink formulation. A core material may include a metal, ceramic, inorganic material, etc. In one exemplary approach, a core material includes aluminum. In another approach, a core material is aluminum. Ag-coated aluminum particles may be obtained commercially.

Embodiments described herein encompass a low-temperature stable silicone-based material with the ideal rheology for 3D printing, which may be custom formulated to yield a wide range of physical properties applicable to a variety of fields and industries. In one example of a conductive optically clear material, a reinforcing filler may be refractive index-matched to impart a 3D conductive silicone structure with transparent optical-grade properties. According to various embodiments described herein, a wide-range of silicone-based 3D structures of varying hardness and stiffness levels may be prepared from silicone-based materials.

In some approaches, the silicone-based ink includes a curing agent. The curing agent may utilize hydrosilylation chemistry during the curing of the 3D structure, such as a platinum curing agent (e.g., Karstedt Pt catalyst), ruthenium curing agent, iridium curing agent, and/or rhodium curing agent. In some approaches, platinum-catalyzed hydrosilylation chemistry (e.g., platinum catalyzed addition of silanes to alkenes) may be used to cure the structure formed with silicone-based inks. In other approaches, ruthenium-catalyzed hydrosilylation chemistry may be used to cure the structures formed with silicone-based inks. In yet other approaches, iridium-catalyzed hydrosilylation chemistry may be used to cure the structures formed with silicone-based inks. In yet other approaches, rhodium-catalyzed hydrosilylation chemistry may be used to cure the structures formed with silicone-based inks.

In some approaches, it is advantageous to use platinum (Pt)-group metal-catalyzed hydrosilylation chemistry because the process does not generate volatile reaction products as compared to condensation cure reactions that produce byproducts such as acetic acid and ethanol. Moreover, these byproducts could deleteriously contribute to some material shrinkage and deviation from the form of the printed 3D structure as deposited.

In some embodiments, the silicone-based ink may include a Pt-group metal curing agent involved in metal catalyzed hydrosilylation chemistry, at a concentration in the range of about 1 to about 1000 ppm, and preferably in a range of about 1 to about 100 ppm, and ideally, 1 to about 50 ppm. In some approaches, the silicone-based ink may include an effective amount of Pt-group metal to initiate a metal-catalyzed hydrosilylation chemistry curing reaction at pre-defined curing conditions, e.g., a pre-defined elevated temperature.

In sharp contrast to siloxane-based inks for 3D printing, the formulation may not include an inhibitor for controlling a rate of curing by the curing agent under ambient atmospheric conditions. The presence of the Ag-coated particles, presumably the presence of Ag, functions as an inhibitor to control the rate of curing by the curing agent. Thus, a secondary inhibitor is not needed in the formulation. The presence of Ag allows a sufficient delay to maximize the printing time before curing and also provides a prolonged pot life duration for extended 3D printing sessions.

In some approaches, in the absence of Ag, the curing mechanism involving the crosslinking reaction may proceed rapidly thereby solidifying the printed part within minutes. However, the addition of the Ag-coated particles or an inhibitor prevents the near spontaneous crosslinking reaction activated by the curing agent and allows sufficient time for extrusion of the ink into a desired architecture.

In some approaches, the curing agent may induce curing in response to ultraviolet radiation. In other approaches, a curing agent may induce curing in response to free radical chemistry. In yet other approaches, the curing agent may induce curing in response to ionizing radiation. Known curing agents may be used in such approaches.

In some embodiments, the silicone-based ink may include a cross-linking agent as used in cure chemistry. For example, one hydrosilylation cure of siloxanes involves a poly(methylhydrosiloxane) containing additive in which the number of methylhydrosiloxane units along the polymeric or oligomeric chain may be greater than 3 per molecule. In various embodiments, through the implementation of dihydride chain extension chemistry, a silicone-based ink may be formed with very low hardness and stiffness that may be applicable to soft robotics and flexible electronics. In some approaches, a cross linking agent may be hydride terminated chain extension additives, for example, a hydride terminated PDMS-poly(hydrogenmethylsiloxane) (PHMS) copolymer. In other approaches, a short chain vinyl terminated PDMS additive may also be included to impart greater hardness to the cured material.

In some embodiments, the silicone-based inks described herein may be stable at low temperatures. Conventional PDMS-based materials exhibit relatively poor temperature stability beyond −45° C. due to PDMS crystallization. In some approaches, the replacement of PDMS with a random copolymer of PDMS and about 2-6 mole % diphenylsiloxane (DPS) may impart low temperature stability of silicone-based ink. For example, incorporation of the diphenyl moieties of DPS may inhibit crystallization of the PDMS chains at reduced temperature. In other approaches, short chain vinyl-terminated PDMS may be used with additional silica filler to decrease the average molecular weight between crosslinking sites thereby resulting in high hardness and stiffness of the 3D printed structure from the silicone-based ink.

In some embodiments, the silicone-based inks may be formulated to yield two-part materials in predetermined ratios. In various approaches, a multimaterial filler may be included in part A or B. In one approach, the addition of filler may be tuned to be in the final print structure by varying mixing ratios. In another approach, using a start-stop capability of the printing technique allows printing a conductive ink in one region and a non-conductive ink in different regions of the same structure.

For example, Part A may include vinyl-terminated poly(dimethylsiloxane)-co-(diphenylsiloxane) macromer, a hydrophobic reinforcing filler, a rheology modifying additive a curing agent, and multimaterial filler; and Part B may include a crosslinker and an additional vinyl-terminated polydimethylsiloxane-co-diphenysiloxane macromer to create a 10:1 2-part A: B system. In some approaches, Part A may be assembled and then may be stored until use. Part B may be assembled and then stored until use. In other approaches, Part A and Part B may be assembled separately and used immediately.

### EXPERIMENTS

### Material and Methods

A poly(diphenylsiloxane-dimethylsiloxane) copolymer (10,000 cSt, ca. 5.5 mole % diphenylsiloxane), PLY3-7560, was obtained from NuSil Technology (Bakersfield, CA). Platinumdivinyltetramethyldisiloxane complex (Karstedt's catalyst, low color, ca. 2%) in xylene was supplied by Gelest, Inc (Morrisville, PA). (SIP6831.2LC), as were DMS-H11 (hydride terminated PDMS, 10 cSt), HMS-053 (trimethyl terminated [4-6% methylhydrosiloxane] dimethylsiloxane, 1000 cSt), DMS-V05 (divinyl PDMS, 8 cSt), and HMS-H271 (hydride terminated [30% methylhydrosiloxane] dimethylsiloxane copolymer, 60 cSt). 1-ethynyl-1-cyclohexanol (ETCH) was supplied by Sigma-Aldrich (St. Louis, MO). Bluesil™ Thixo Add 22646 was supplied by Elkem Silicones (Oslo, Norway). Aerosil® R812S, Aerosil R8200, and Sipernat® D13 were supplied by Evonik Industries (Essen, Germany), SIS 6962.1M30 was obtained from Gelest, and Cabosil EH5 was obtained from Cabot Corp (Boston, MA). Silver coated aluminum powder AL-M-02-P.AGC was obtained from American Elements (Los Angeles, CA) and Tuball Matrix 602 (TM-602) was obtained from OCSiAl USA (Gahanna, OH). All materials were used as-is without further purification. Formulations were prepared using a Flacktek DAC 150.1 FVZ-K SpeedMixer™ (Landrum, SC) for compounding. Catalyst cure temperatures and ink thermal response values were measured using a TA Instruments Discovery DSC (New Castle, DE) differential scanning calorimeter using Tzero® aluminum sample pans (NDS Surgical Imaging, Sunnyvale, CA). Yield stress, viscosity, pot life measurements, and cure profiles were obtained with a TA Instruments AR2000EX rheometer equipped with a cross-hatched 25 mm Peltier parallel plate under a 1 mm sample gap spacing.

Once formulated, all silicone-based inks were filtered (pressurized air, 90 psi) through a Swagelok 140 μm mesh filter (Solon, OH) into 30 mL syringe barrels (Nordson EFD Optimum, East Providence, RI) and centrifuged (Nordson EFD ProcessMate 5000) to eliminate entrapped air. A flat-ended piston was inserted to seal the rear of the syringe; whereas, the syringe tip was equipped with a smooth-flow tapered nozzle (250 μm inner diameter) via luer-lock. The syringe was attached to a positive-displacement dispenser (Ultra 2800, Nordson EFD), which supplied the appropriate displacement to extrude ink through the nozzle. The syringe system was subsequently affixed to the z-axis of a custom Aerotech air-bearing gantry xy open frame movement stage, which was controlled via an A3200 controller through an Aerotech A3200 CNC operator interface (v5.05.000) (Aerotech Consumer Aerospace, Pittsburgh, PA). G-code instructions were programmed and run through the controller software to generate continuous lattice structures with varying density and strand orientation, e.g., 50% density face centered tetragonal (FCT) lattice. The lattice structures were printed onto silicon wafers with each layer of parallel filaments being printed orthogonal to the previous layer, yielding an FCT structural arrangement. The printed lattices were cured in a Yamato ADP300C vacuum drying oven (Yamato Scientific America, Inc, Santa Clara, CA).

Shore hardness values were obtained by preparing solid “pucks” of silicone material that were cured at 150° C. for 12-16 hours. Durometer values were measured at several different locations with a PTC Instruments Model 408 Type A Durometer (Los Angeles, CA). Printed lattice structures were sectioned with a razor blade and cross-sectional images were obtained with a Zeiss SteREO Discovery.V12 microscope (Zeiss, Dublin, CA) equipped with an Axiocam ICc 5 camera and analyzed with Axio Vision software to measure the diameters of the printed filaments, individual layer heights, and total heights of the printed FCT lattices.

Example Preparation of Silicone-based Ink with Ag-CNT filler

A Flacktek cup was charged with NuSil PLY3-7560 silicone polymer (67 wt. %), platinum catalyst (13 ppm), and Aerosil® R8200 fumed silica (32 wt. %) and spun at 2000 rpm for 30 seconds; the sides of the cup were scraped, and the blend was speed-mixed again under the same conditions. Bluesil™ Thixo Additive 22646 (0.3 wt. %) was added to the mixture, followed by speed-mixing at 2000 rpm for 30 seconds. To this mix, masses of Tuball Matrix 602 (TM-602) and silver coated aluminum were subsequently added to the mix at masses to achieve a target resistance, and the mixture was speed-mixed at 2000 rpm for 45 seconds under vacuum. This mixture was left to cool down to room temperature. A separate mixture having Nusil PLY3 (28 wt. %), Gelest HMS-H271 (45 wt. %), and Gelest DMS-V05 (27 wt. %) were added to a Flacktek cup and spun at 2000 rpm for 30 seconds. The two resulting mixtures were mixed by speed-mixing at 1400 rpm for 30 seconds. The sides of the cup were scraped, and the dispersion blend was speed-mixed again under the same conditions, yielding a viscous polysiloxane ink.

### Effect of Silver and CNT on Resistivity of Elastomer Material

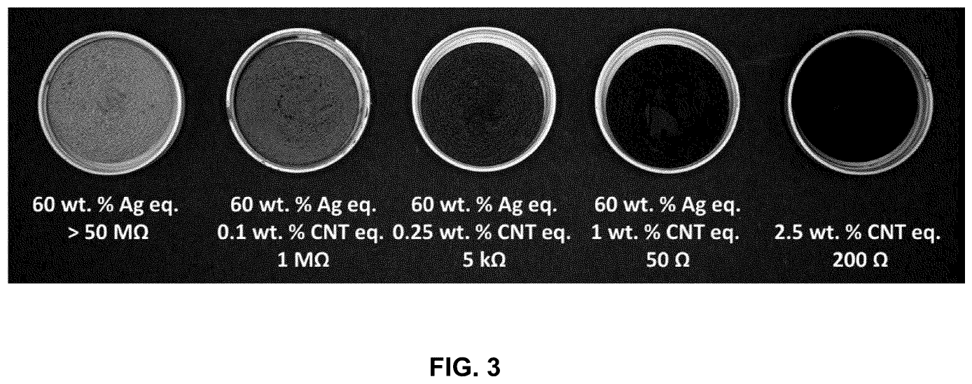

FIG. 3 illustrates the effect of silver and a high aspect ratio filler such as CNT on resistivity of elastomer material. Silicone-based ink was loaded with 60 wt. % Ag-coated Al particles with varying amounts of CNTs added to the ink. In this assay, CNTs were SWCNTs. The ink was cast into puck-shaped structures and cured. The elastomer having only Ag-coated Al particles had a high resistivity of greater than 50 MΩ. This formulation is right on the threshold of where this material becomes unprintable due to the high weight content of Ag-coated Al particles. Formulations having higher than 60 wt. % Ag-coated cannot be extruded from the nozzle. Addition of the lowest amount of CNT, 0.1 wt. % CNT reduces the resistivity of the material to 1 MΩ, and as higher concentrations of CNT, e.g., 0.25 wt. % and 1 wt. %, are added to the formulation with 60 wt. % Ag—Al, the cured material has a significant drop in resistivity, 5 kΩ and 50Ω, respectively. Addition of 0.1 wt. % CNT causes a 50 fold decrease in resistivity (50 MΩ to 1 MΩ) and addition of 2.5× high aspect ratio filler, 0.25 wt. % CNT causes a further 200 fold decrease in resistivity (1 MΩ to 5 k Ω). The resistivity of the material is significantly affected by the presence of CNTs in a range of great 0 wt. % to less than 2.5 wt. % in the formulation. A silicone formulation that includes high loading of CNTs without Ag—Al, having 2.5 wt. % CNTs, was not printable and has a higher resistivity than the combined Ag—Al and CNT samples. The combination of Ag—Al particles and high aspect ratio CNTs is more advantageous for the ink formulation than either filler on its own.

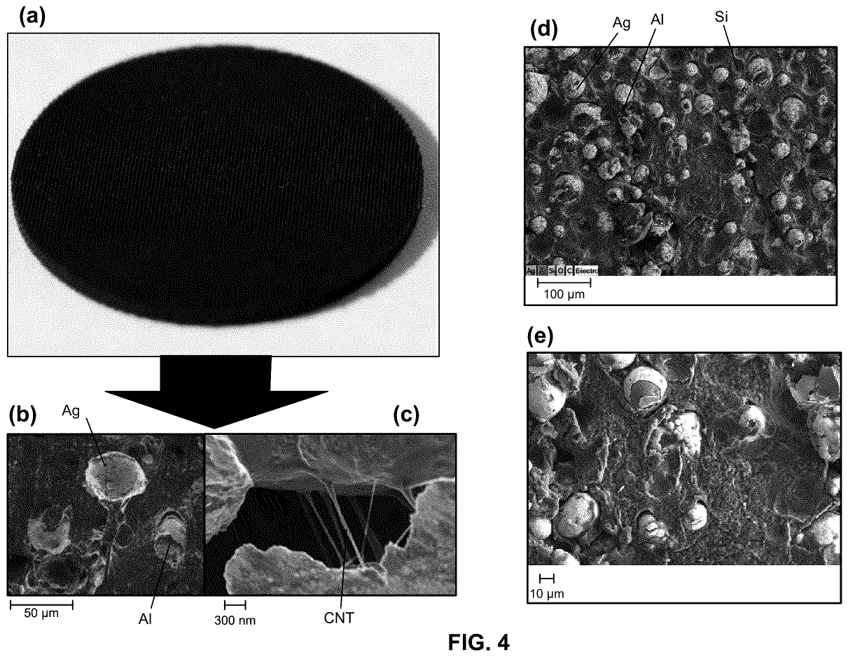

FIG. 4 illustrates images of a 3D printed structure having 50% porosity. The % porosity was calculated based on nozzle size and toolpath, specifically spacing between extruded filaments. Part (a) is an image of a 3D printed puck formed by extrusion of a continuous filament of silicone ink having a tuned architecture that includes geometrically arranged strands with spacing between the strands to achieve a 50% porosity.

Part (b) illustrates a scanning electron microscopy (SEM) image of a portion of the silicone-Ag-CNT material. The Ag—Al particles are highlighted as indicated. Each particle has an Al core as indicated in the darker staining. Part (c) illustrates a magnified view of a portion of the silicone-Ag-CNT material where the CNTs form a web-type architecture between the particles. Part (d) is a SEM image of a larger field of material showing the Ag-coated Al particles and Silicone-based matrix. Part (e) illustrates a 10-fold magnified view of the image of part (d).

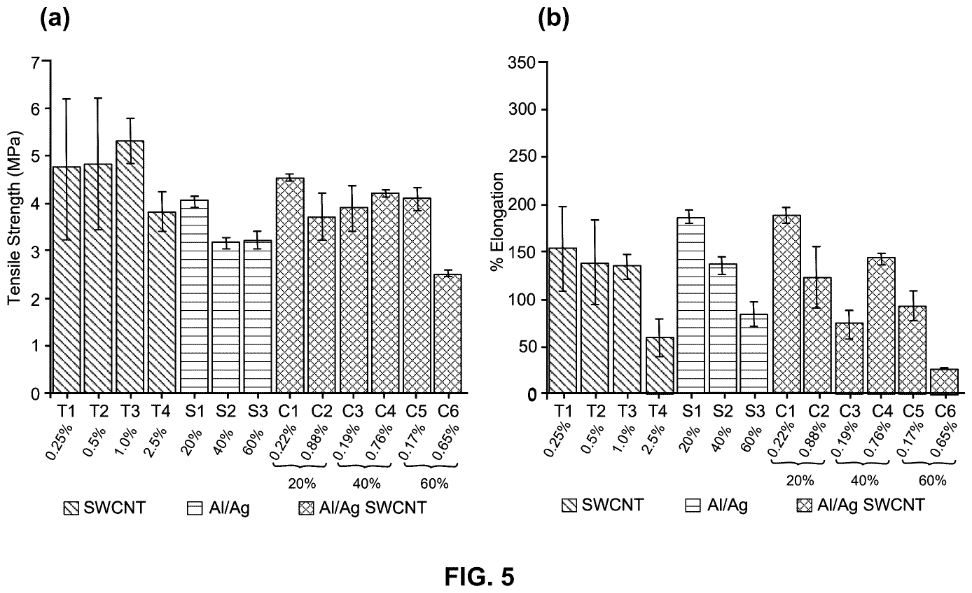

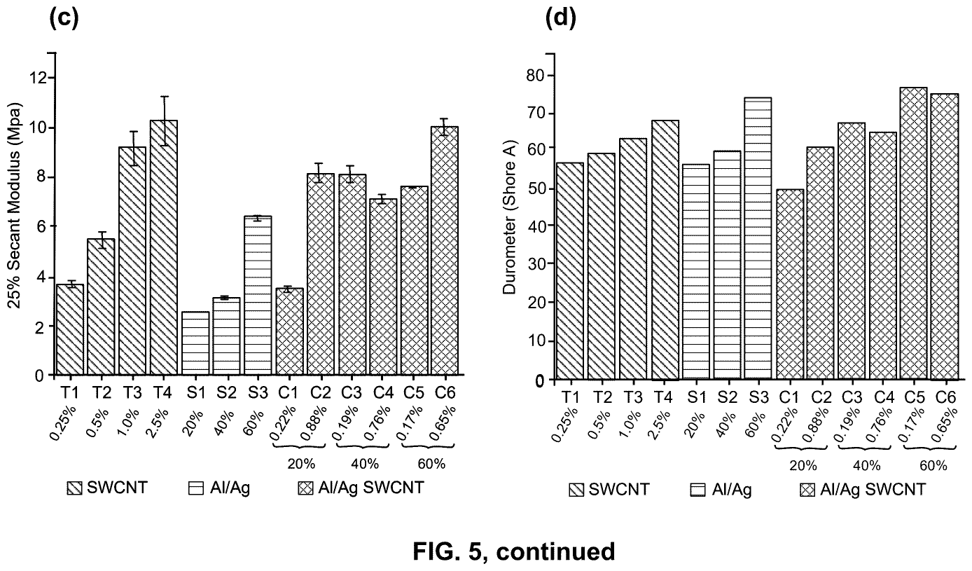

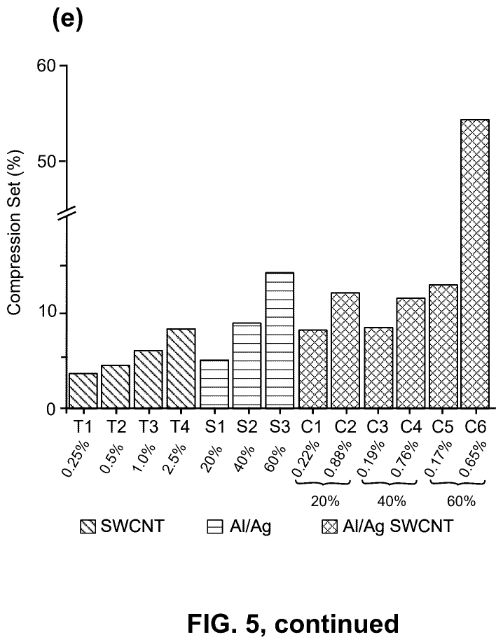

FIG. 5 illustrates a series of plots of physical properties of casted sheets of cured silicone material that have SWCNT filler alone (diagonal pattern), Ag—Al particles alone (horizontal stripe pattern), and a combination of Ag—Al-particles and SWCNTs (hash pattern). Part (a) is a plot of tensile strength (MPa) of each of the samples that measure the mechanical properties of each sample. The values represent a maximum strength at which the sample withstands a tensile load before it snaps or rips apart. At the higher loadings of Ag—Al particles (S2 and S3) and SWCNTs (T4), the tensile strength decreases. The combination of Ag—Al particles with SWCNTs demonstrated a remarkable decrease in tensile strength in sample C6 that has the largest loading of SWCNTs (0.65 wt. %) and Al—Ag (60 wt. %). All samples, however, demonstrated good tensile strength (except C6) above 3 MPa, which is remarkable compared to other elastomer materials that do not include silver or CNTs.

Part (b) is a plot of elongation that measures the maximum tensile elongation before the sample part breaks. The measurements of maximum elongation include percent extension of the part compared to the part at 0% strain. The ability of the parts to elongate is significantly decreased, showing significant increased rigidity, in the samples with greater amounts of filler, with the most significant reduction in elongation in sample C6 having the combination of 60 wt. % Ag—Al particles and 0.65 wt. % SWCNTs.

Part (c) is a plot of 25% secant modulus which measures the modulus of elasticity of the material, for example, a tensile modulus for a lower strain, and in these measurements, between 0 and 25% strain. Increasing the amount of rigid fillers (SWCNTs and/or Al/Ag) to the silicone ink formulation causes the 25% secant modulus to increase accordingly. The combination of SWCNT and Ag-coated Al particles, samples C2-C5, seems to provide consistent measurements of secant modulus.

Part (d) is a plot of durometer measurements, e.g., Shore A, of each sample. The durometer measurement is a standardized method that involves a durometer tester to determine softness of the material. Increasing the amount of rigid fillers (SWCNTs and/or Al/Ag) to the silicone ink formulation causes the durometer reading to increase accordingly.

Part (e) is a plot of compression set of the parts. The measurement of compression set assesses the extent of elasticity of a sample under a longer term load. The sample pucks are compressed to about 25% strain, and then placed in an oven for heating at 70° C. for 72 hours. The height of the pucks is measured before and after the heating. The elastomeric property of springing back to its original shape is reflected by a lower % compression set. The lower the compression set (i.e., the set in plasticity compression) contributes to the change in the height. Increasing the amount of rigid fillers (SWCNTs and/or Ag/Al) to the silicone ink formulation causes the % compression set to increase demonstrating the decreased elasticity of the material with increased amounts of rigid fillers. It is interesting that the combination of SWCNTs and Ag-coated Al (Ag/Al) particles did not appear to have an additive effect on raising the compression set in the samples (C₁-C₅) except for sample C6 that has 60 wt. % Ag-coated Al particles and 0.65% SWCNTs which demonstrated a significant increase in compression set suggesting very little elasticity in the sample. Moreover, sample C6 demonstrates a loading threshold at which there is so much filler present that the siloxane polymer cannot fully wet the filled materials, thereby causing void spots, etc. that cause the material to lose its elastic character.

Table 1 lists examples of loadings of Ag-coated Al particles and SWCNTs in siloxane ink. In one approach, wt. % is useful for formulations because it allows calculation of relative mass material if each component in the ink composition. Alternatively, for percolative networks and volume distribution of different materials in the formed polymer matrix, calculations are based on volume. % (vol. %) loading. The vol. % loadings provide an estimation of how much space is being taken up by the conductive materials in the silicone matrix. Volume and weight content may be interchangeable and dictated by density. The different weight loadings of CNTs in the formulations did not demonstrate a remarkable change in the volume loadings as expected based on the density. The formulations were adjusted to try to match and compare the C samples (Ag/Al+CNT) to the T (CNT only) and S (Ag/Al only) samples. The vol. % loadings were estimated to be equivalent with the consideration of the calculation of vol. % for the formulations having two different fillers (e.g., Ag/Al and CNTs).

TABLE 1
Ag-coated Al particles and SWCNT loadings in siloxane ink

| | CNT | Al/Ag | CNT | Al/Ag |
|---|---|---|---|---|
| | Loading | Loading | Loading | Loading |
| Material | Wt. % | Wt. % | Vol. % | Vol. % |
| T1 | 0.00 | 0 | 0.00 | 0.00 |
| T2 | 0.25 | 0 | 0.16 | 0.00 |
| T3 | 0.50 | 0 | 0.32 | 0.00 |
| T4 | 2.50 | 0 | 0.63 | 0.00 |
| S1 | 0.00 | 20 | 1.59 | 9.59 |
| S2 | 0.00 | 40 | 0.00 | 22.05 |
| S3 | 0.00 | 60 | 0.00 | 38.90 |
| C1 | 0.22 | 20 | 0.16 | 9.61 |
| C2 | 0.88 | 20 | 0.63 | 9.65 |
| C3 | 0.19 | 40 | 0.16 | 22.08 |
| C4 | 0.76 | 40 | 0.63 | 22.17 |
| C5 | 0.17 | 60 | 0.16 | 38.95 |
| C6 | 0.65 | 60 | 0.63 | 39.08 |

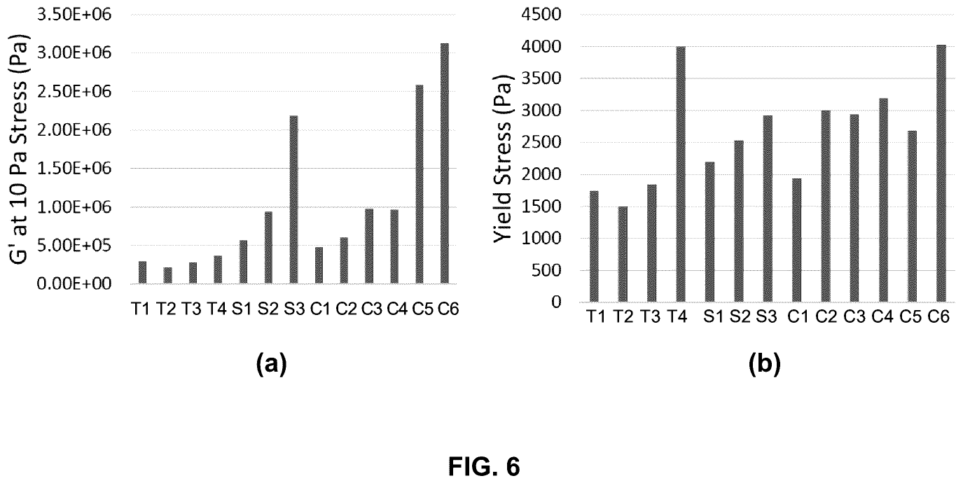

The plots of FIG. 6 depict the rheological properties of the silicone ink formulations having SWCNTs (T1, T2, T3, T4), Ag-coated Al particles (S1, S2, S3), and SWCNTs and Ag-coated Al particles (C1, C2, C3, C4, C5, C6). Part (a) illustrates the storage modulus (G′) at 10 Pa Stress for each of the ink formulations. All formulations demonstrated low storage modulus of elastic energy except the ink formulations having 60 wt. % Ag/Al (S3, C5, and C6.

Part (b) of FIG. 6 depicts yield stress of the ink formulations. All the formulations were extrudable except C6. It was interesting that sample T4 (2.5 wt. % SWCNT) was extrudable but demonstrated comparable yield stress as C6. It was noted that yield stress measurements are an instrument-related limitation, so application of sufficient force can overcome yield stress and the ink formulation may be extruded.

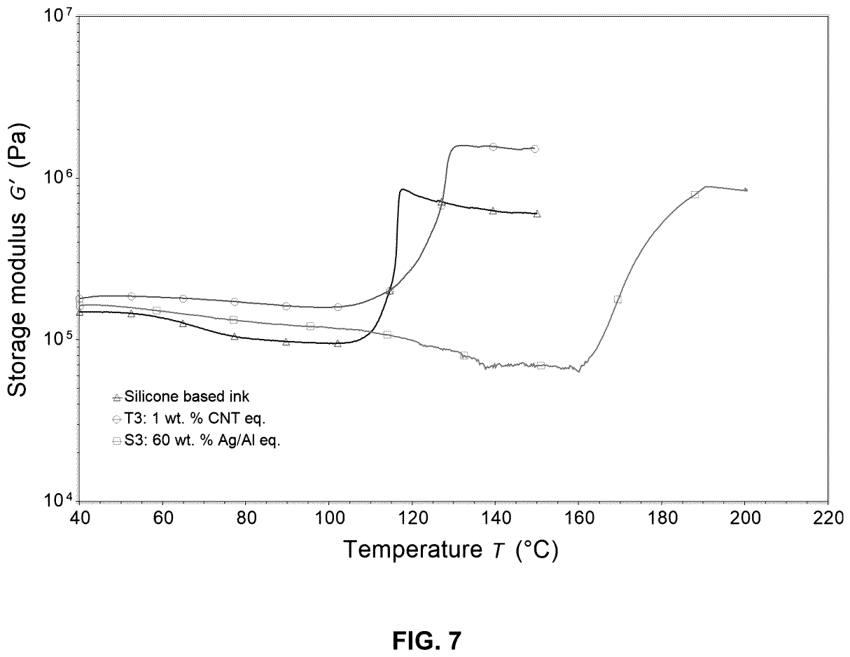

The plot of FIG. 7 depicts the rheological properties of the ink formulations during curing over time with the addition of heat. Three ink formulations were assessed: silicone-based ink without added fillers (A), silicone-based ink with 1 wt. % SWCNTs (o), and silicone-based ink with 60 wt. % Ag-coated Al particles (□). For silicone without conductive filler, the curing starts at about 110° C. with a sharp increase in storage modulus. The curing also starts at about 110° C. for silicone with 1 wt. % SWCNTs. It was surprising to note that the high loading (60 wt. %) of silver functions also as a cure inhibitor. The curing in the silicone-based ink with the Ag-coated Al particles (u) started curing at a significantly higher temperature (about 160° C.) compared to the silicone-based ink formulation with SWCNTs (o) and the ink formulation without any added fillers. Without wishing to be bound by any theory, it is believed that the presence of Ag slows the curing reaction in the silicone-based ink formulation. The Ag-ink formulation is cured, but the kinetics and/or thermodynamics are changed. The presence of silver (Ag) in the conductive ink formulation allows an extension of pot life. Inhibitors are used often in silicone-based ink formulations, but their effectiveness has limitations. The presence of Ag is a non-traditional inhibitor, and thus, Ag's inhibitory affect was definitely surprising. The additive inhibitory affect may be removed from the ink formulation by removing the crosslinking inhibitor that is typically included with silicone-based ink formulations. Silicone-based ink formulations with Ag-coated particles that do not include a crosslinking inhibitor cure at a similar temperature and in a similar time as silicone-based ink formulations with the crosslinking inhibitor in the absence of silver.

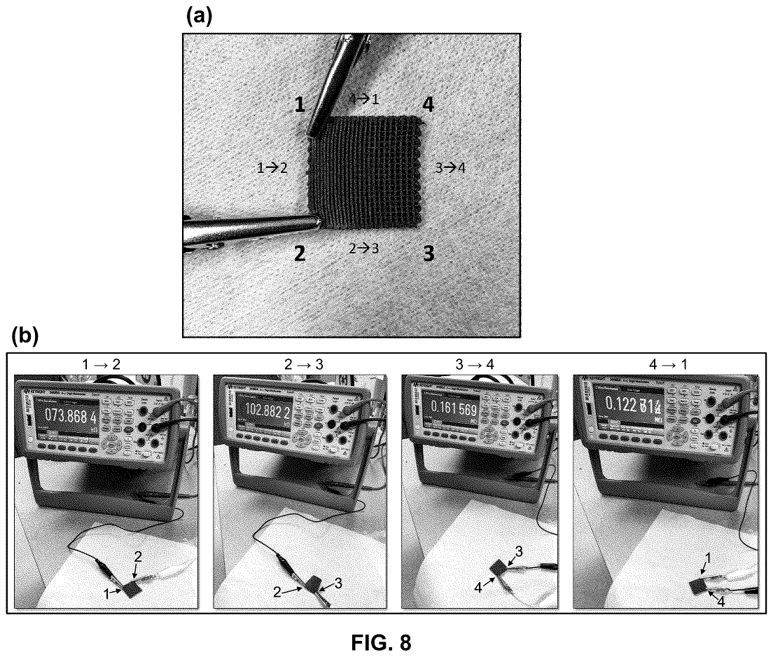

The image of FIG. 8 illustrates a 3D silicone structure having gradient porosity that results in different measured resistance according to porosity of the region measured. Density can be tuned in a printed structure to spatially control resistance. As illustrated in part (a), using a C5 ink formulation (0.17 wt. % CNTs+60 wt. % Ag/Al), a predefined toolpath for DIW printed strands with tight spacing between the strands (1, 2), and the spacing gradually increased between the strands and the extruded filament progressed toward the other end of the 3D structure (3,4). The DIW technique provided a predefined toolpath to print a 3D structure having gradient porosity as defined by a stepwise increase in spacing between the extruded strands that form a single layer.

Part (b) of FIG. 8 is a series of images measuring the resistance of the part using a multimeter with a black probe and a white probe to measure the resistance. The probes are connected to different contact points (1, 2, 3, 4) on the 3D printed part. These values indicate that the electrical resistance may be tuned along a path. Table 2 lists the measured resistance between the contact points of the 3D printed structure. The gradient of conductance is demonstrated by greater conductance in the region between points 1 and 2 where the spacing between the strands is the smallest, and the conductance decreases as the spacing between the strands increases. The lowest resistance is measured between the points 1 and 2 in the region of the part that has the greatest density. The least

TABLE 2
Measured resistance across a defined gradient
of a 3D printed elastomer part

| Path | Measured Resistance (kΩ) |
|---|---|
| 1 → 2 (most dense) | 73.9 |
| 2 → 3 | 102.9 |
| 3 → 4 (least dense) | 161.6 |
| 4 → 1 | 122.7 |
| 2 → 4 | 110.8 |
| 1 → 3 | 118.4 |

dense region of the part, where the largest spacing is between the strands, between points 3 and 4, the conductivity is the lowest and the measured resistance is the highest value on the part.

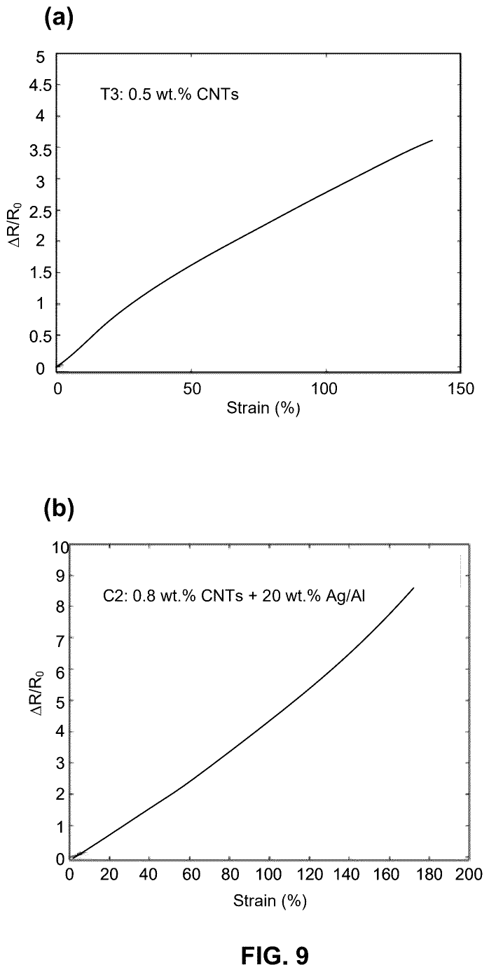

FIG. 9 illustrates plots of silicone sheets that demonstrate an electrical resistance variation to tensile strain. A value of electrical resistance variation (ΔR/R₀) refers to the fractional change in resistance AR compared to its initial resistance R₀. As a sample is stretched, the geometry changes such that the sample is lengthened, and the cross-section area decreases thereby increasing the resistance. For each sample, T3 in part (a) and C2 in part (b), the electrical resistance increases with increased strain. The different material composition of each sample may affect the trend of the electrical response versus strain. The magnitude of an electrical resistance (ΔR/R₀) was greater with the C2 sample (part (b)) that had a material composition including CNTs and Ag/Al compared with the T3 sample (part (a) that had a material composition including only CNTs as a filler. The magnitude electrical resistance of C2 at 100% strain was about 4 whereas the magnitude of electrical resistance of T3 was about 2.5.

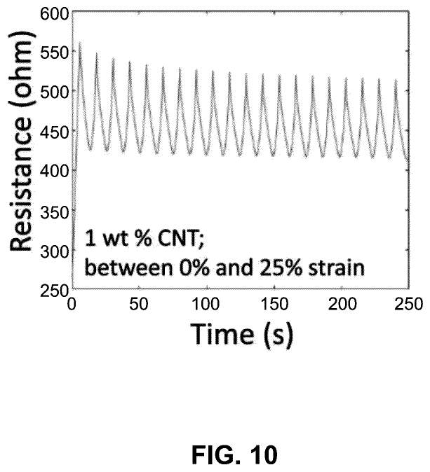

FIG. 10 is a plot of resistance of a sample having 1 wt. % CNTs during multiple cycles of strain over time. Each resistance measurement is an absolute value of resistance between cycles of strain. Initially, at time 0, the resistance of the sample is low about 250Ω, and with the first cycle of strain the resistance increases to just above 550 Ω. Over time, the cycles of resistance level out between 0% and 25% strain. The peak strain decreases over time to just above 500Ω and the trough stabilizes. The cycles become repeatable for each application of strain.

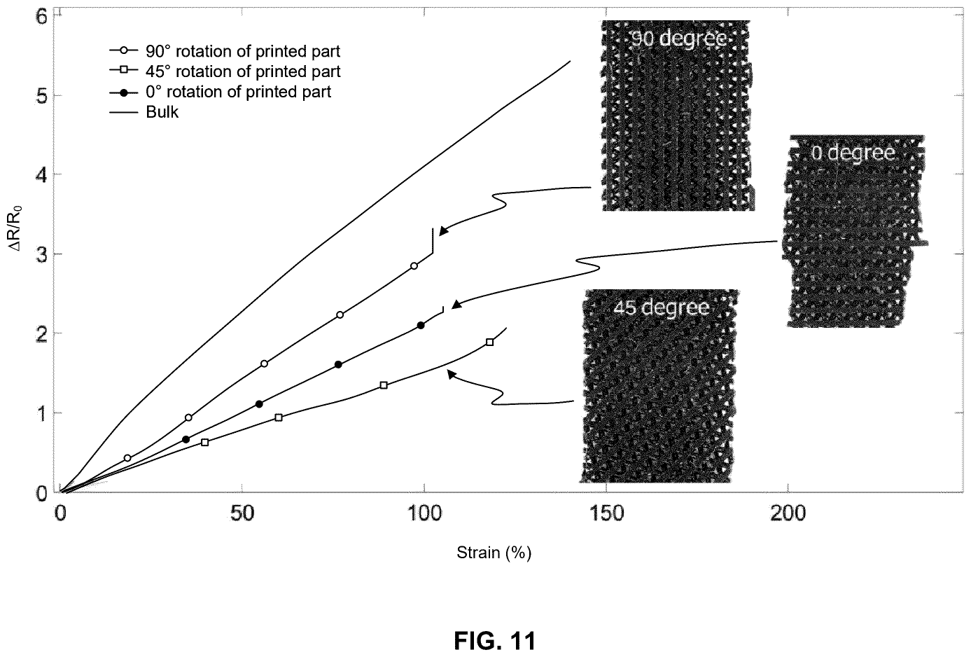

FIG. 11 illustrates a directionally-dependent electrical response to tensile strain. A bulk sample of a cast sheet (solid line) was prepared form the silicone formulation with CNT filler, and a sample was 3D printed using a silicone formulation having a CNT filler to form a lattice-type 3D structure (●, □ and ∘). The printed sample was rotated (0°●, 45°□, and 90° ∘) and tested for electrical response (ΔR/R₀) in response to applied strain. The bulk sample (solid line) demonstrated a large electrical response (ΔR/R₀) at any given strain. The printed 3D structure demonstrated a large electrical response (ΔR/R₀) that may be changed depending on the orientation of the strands. At 90° rotation (o) of the structure, where the top facing strands are vertical in the plane of the page (see image) the electrical response is increased from the 0° rotation (●) where the top strands are horizontal in the plane of the page. A rotation of the structure of 45° (∘), where the top facing strands are diagonal in the plane of the page, the electrical response is between the 0° and 90° rotation. There is a change in resistance with the change in rotation of the printed structure.

FIG. 12 illustrates a plot of compression testing of conductive foam that shows electrical response to compressive strain. There is a change in electrical sensitivity under compressive modes in 3D printed foams. The plots of parts (a) and (b) illustrate normalized resistance in response to compression thereby demonstrating an electrical response to compression. A lattice-like 3D printed sample of the silicone formulation demonstrates an increase in normalized resistance in response to compression (part (a)) whereas a bulk sample of the same silicone formulation demonstrates a decrease in normalized resistance in response to compression (part (b)).

The images in FIGS. 13A-13C illustrate an engraved surface of a silicone/Ag/CNT structure. A surface of a 3D printed structure of silicone/Ag/CNT material (printed using DIW process) was etched with a tool that etches polymer structures such as a laser. Part (a) of FIG. 13A is an image of a surface of a CNT loaded silicone sheet. The As Cured Region is the surface of the structure, and the Laser Etched Region is a pattern within the boundaries of the As Cured Region. Part (b) is a magnified view of the Laser Etched Region “A” that has a measured resistance of about 160K Ω. The Laser Etched Region has a disrupted surface compared to a similar magnified view of As Cured Region in part (c) where the silicone skin layer has been removed to expose the conductive filler. The As Cured Region “B” that has a measured resistance of about 3M Ω.

FIG. 13B is an image of the 3D structure having a laser etched region on one of its surfaces. The 3D structure is about 13790 μm (13.79 mm)×15000 μm (15 mm)×1090 μm (1 mm). FIG. 13C is an image that shows the engraving of the surface having a depth and depth-gradient of laser etching achieved using a UV laser with a 100 mm/s scan speed, and 50 kHz pulse frequency.

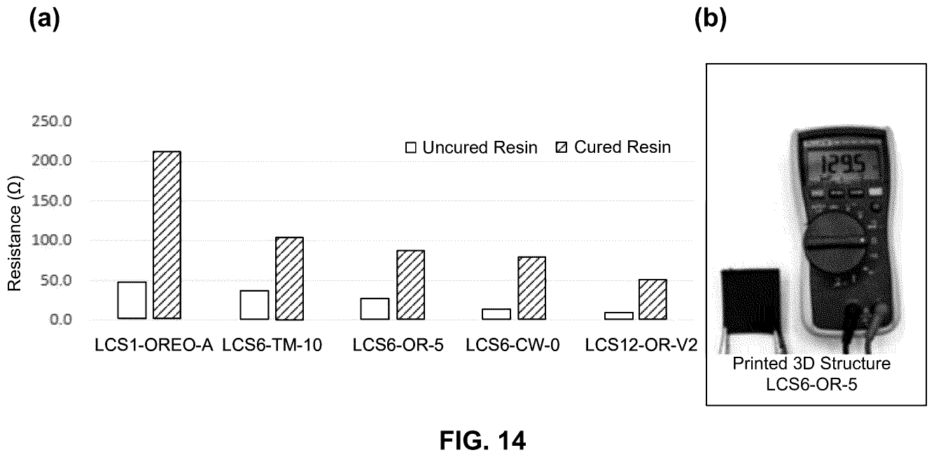

FIG. 14 illustrates the resistance of cured and uncured resin formulations. Part (a) is a comparison of the resistance of different formulations that are uncured (white bars) and the same formulation of resin cured as a bulk cast sheet (striped bars). The different resin/ink formulations demonstrated conductivity of the ink/resin also maintained conductivity after DIW printing and curing. All the resin variations were prepared using the sub-formulations of a variant of the Llama 20.03 Base and the Llama 20.03 Part B, and each of these parts are described in Table 3 below.

TABLE 3
Formulations of Sub-Parts of Resin Formulations

| | | | |
|---|---|---|---|
| Component | Amount (g) | Composition | Units |

Llama 20.03 Base

| | | | |
|---|---|---|---|
| PLY4-7560 | 41.7 | 49.0 | wt. % |
| PLY3-7560 | 73.5 | 27.8 | wt. % |
| Pt-PL | 0.9 | 13.1 | ppm Pt |
| Aerosil R8200 | 33 | 22.0 | wt. % |
| Bluesil Thixo ADD 22646 | 0.9 | 0.6 | wt. % |

Llama 20.03 Part B

| | | | |
|---|---|---|---|
| Gelest HMS-501 | 7 | 14 | wt. % |
| PLY3-7560 Lot 101188 | 40 | 80 | wt. % |

The formulations for each resin shown in FIG. 14 are listed below in Table 4A and 4B. The resin formulations differed such that the Llama 20.03 Base for each formulation included a different amount of Aerosil R8200. Aerosil R8200 is a structural silica filler, and can help with rheology and mechanical strength, but it also takes up solids volume in the formulation, and removing it allows more “space” for conductive filler (e.g., Al/Ag, SWCNT) to be loaded. Each formulation included Llama 20.03 Part B which did not include crosslinking inhibitor because the silver (Ag/Al) functioned as an inhibitor, so no additional inhibitor was needed. Each formulation included™-602 which is a 10 wt. % SWCNT concentration and Al/Ag. For the resin formulation listed in Table 4B, LCS12-OR-V2 used the same 5 wt. % R8200 Llama 20.03 base as LCS6-OR-5 (Table 4A), but had twice the amount of™ 602 (SWCNT).

Table 5 below lists the resistance values for each sample formed with the resins listed in Tables 4A-4B. Curing each formulation into a cast sheet increases the measured resistance of the formulation.

TABLE 4A
Formulations of Resins with Llama 20.03 Base Variants

| | LCS- | LCS6- | LCS6- | LSC6- |
|---|---|---|---|---|
| | OREO-A | TM-10 | OR-5 | CW-0 |
| | 20 wt. % | 10 wt. % | 5 wt. % | 0 wt. % |
| | Aerosil | Aerosil | Aerosil | Aerosil |
| Component | Amount (g) | Amount (g) | Amount (g) | Amount (g) |
| Llama 20.03 | 16.1 | 16.1 | 16.1 | 16.1 |
| Base with | | | | |
| variable | | | | |
| Aerosil loading | | | | |
| TM-602 | 3.575 | 3.575 | 3.575 | 3.575 |
| SWCNT | | | | |
| Ag/Al | 33.0 | 33.0 | 33.0 | 33.0 |
| Part B (w/o | 1.964 | 1.72 | 1.823 | 1.94 |
| inhib.) | | | | |

TABLE 4B
Formulation of Resin LCS12-OR-V2
LCS12-OR-V2

| Component | Amount (g) | wt. % |
|---|---|---|
| Llama 20.03 Base variant with 10 | 16.100 | 0.277 |
| wt. % Aerosil | | |
| TM-602 SWCNT | 7.150 | 0.123 |
| Ag/Al | 33.0 | 0.568 |
| Part B (w/o inhib.) | 1.823 | 0.031 |

TABLE 5
Resistance of uncured resin and cured cast sheets

| | Uncured Resin | Cured cast sheet |
|---|---|---|
| Variant Name | Resistance (Ω) | Resistance (Ω) |
| LCS1-OREO-A | 45.0 | 204.0 |
| LCS6-TM-10 | 35.0 | 104.0 |
| LCS6-OR-5 | 25.0 | 85.0 |
| LCS6-CW-0 | 12.0 | 78.0 |
| LCS12-OR-V2 | 7.0 | 50.0 |

Part (b) is an image of a 3D printed structure using the formulation LCS6-OR-5. The measured resistance of the structure is 129.5Ωwhich is greater than the resistance of the cured cast sheet made from the same formulation (85.0Ω). These results demonstrate that printing the formulation into a defined complex architecture increases the resistance of the material. The bulk material is more conductive than a printed porous structure.

### In Use

Various embodiments described herein develop DIW 3D printable inks that may be used on conductive substrates to act as a compliant porous foam that also serves functionally to transfer electrical charges across it. The ink may also be laser etched to sinter the conductive filler to enhance conductivity. Applications may include using the material as a 3D printable functional ink for soft wearable electronics, soft foams for structural monitoring, and integrated sensors for robotics. The following are some potential uses: addition cure silicone elastomer, including reinforcing filler for enhanced tear strength, including thixotropic agent for shape retention at room temperature, etc. In one approach, an ink includes a mixture of silver coated aluminum and single walled carbon nanotubes to achieve a conductive bridging pathway while still retaining good thixotropic behavior. In one approach, a composition may be cast as a conductive adhesive paste between two conductive interfaces. In one approach, a composition may be extruded into a free-standing structure such as a strand to create conductive three-dimensional elastomers with gap-spanning capability using DIW printing. In one approach, a composition may be used to introduce anisotropic electrical conduction in XY or Z planes of printed parts. In one approach, a composition may be used to form flexible, resistive pathways of electrical heating elements. In one approach, a composition may be combined with a non-conductive silicone ink to print multi-material structures with custom architecture with tailored placement of conductive traces. In one approach, a composition may be used to print integrated soft electronics including strain and pressure sensors. In one approach, the cure kinetics of the ink can be controlled by using tailored loading of Al/Ag as an in-situ inhibitor. In one approach, the surface of the ink may be sintered using laser etching to create high conductivity surfaces on the elastomer. In one approach, laser etched silicone surfaces can be plated for local conductivity enhancement or passivation.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A product of additive manufacturing with a multimaterial silicone-based ink, the product comprising:
a printed three-dimensional structure comprising filaments in a predefined geometric arrangement, the filaments comprising a silicone-based matrix and a multimaterial filler,
wherein the printed three-dimensional structure is configured to have a predefined electrical resistance characteristic,
wherein the predefined electrical resistance characteristic is a function of the predefined geometric arrangement of the filaments.

2. The product as recited in claim 1, wherein the structure is characterized by regions having different density defined by the predefined geometric arrangement of filaments.

3. The product as recited in claim 2, wherein the structure is characterized by regions having different electrical resistance in dependence upon the density of the respective region.

4. The product as recited in claim 1, wherein the structure is characterized by exhibiting a different average electrical resistance per unit length between first and second reference points on the structure than between third and fourth reference points that are on a second imaginary line aligned at an angle greater than 0 degrees from a first imaginary line that intersects the first and second reference points.

5. The product as recited in claim 1, wherein the structure is characterized as having a predefined gradient of porosity across the structure.

6. The product as recited in claim 5, wherein the predefined gradient of porosity is a gradient in at least one direction chosen from an x-direction, a y-direction, a z-direction, across an x-y plane, across an x-z plane, across a y-z plane, and a combination thereof.

7. The product as recited in claim 1, wherein the structure is resiliently deformable and exhibits a change of resistivity in a portion of the structure subjected to a strain chosen from compression, bending, and stretching.

8. The product as recited in claim 1, wherein the product includes a strain sensor configured to detect a change in resistance of the structure upon deformation of the structure caused by an exertion of a strain thereon, the strain chosen from compression, bending, and stretching.

9. The product as recited in claim 1, wherein a portion of a surface of the structure has physical characteristics of being engraved by laser etching.

10. The product as recited in claim 9, wherein an entire area of the engraved portion of the surface of the structure is smaller than an entire area of the surface.

11. The product as recited in claim 9, further comprising an uncured multimaterial-silicone material that provides local electrical conductivity at the engraved portion on the surface of the structure.

12. The product as recited in claim 1, wherein the product includes two features defining a gap therebetween, wherein the structure is a free-standing structure that spans the gap.

13. The product as recited in claim 1, wherein the product is a conductive adhesive material positioned between two conductive interfaces.

14. The product as recited in claim 1, wherein the structure comprises non-conductive filaments that define placement of the filaments comprising the silicone-based matrix and multimaterial filler in the predefined geometric arrangement of filaments.

15. The product as recited in claim 14, wherein the filaments comprising the silicone-based matrix and multimaterial filler provide at least one conductive trace according to a predefined path across the structure.

16. The product as recited in claim 1, wherein the multimaterial filler comprises a plurality of conductive particles and a fiber-based filler.

17. The product as recited in claim 16, wherein the fiber-based filler comprises fiber having an aspect ratio greater than about 10.

18. The product as recited in claim 16, wherein the fiber-based filler is chosen from single walled carbon nanotubes (SWCNT), multi-walled carbon nanotubes (MWCNT), conductive nanowires, carbon spheres, carbon platelets, and carbon nanofibers.

19. The product as recited in claim 16, wherein the conductive particles include silver-coated particles.

20. A method of forming an electrically conductive three-dimensional structure using a multimaterial silicone-based ink, the method comprising:
determining desired resistance characteristics of a desired structure;
selecting a geometric arrangement of filaments that will provide the resulting desired resistance characteristics of the desired structure;
printing the desired structure based on the selected geometric arrangement of filaments to impart the desired resistance characteristics on the printed structure; and
curing the desired structure to at least a predefined extent.

21. The method of claim 20, wherein the structure is a self-supporting three-dimensional structure.

22. The method of claim 20, wherein the structure is printed using direct ink writing.
